(19) United States
(12) Patent Application Publication
(10) Pub. No.: US 2026/0067925 A1
(43) Pub. Date: Mar. 5, 2026

(54) COORDINATED BEAMFORMING INDICATION AND PROCESSING

(71) Applicant: QUALCOMM Incorporated, San Diego, CA (US)

(72) Inventors: Sameer VERMANI, San Diego, CA (US); Bin TIAN, San Diego, CA (US); Jialing Li CHEN, San Diego, CA (US); Youhan KIM, Saratoga, CA (US); Meriam REZK, Campbell, CA (US); Deniz RENDE, San Jose, CA (US)

(21) Appl. No.: 19/318,217

(22) Filed: Sep. 3, 2025

Related U.S. Application Data
(60) Provisional application No. 63/690,712, filed on Sep. 4, 2024.
(60) Provisional application No. 63/710,558, filed on Oct. 22, 2024.

(51) Int. Cl. H04W 74/04; H04W 16/28; H04W 74/00; H04W 84/12

(52) U.S. Cl. CPC H04W 74/04; H04W 16/28; H04W 74/002; H04W 84/12

(57) ABSTRACT

Certain aspects of the present disclosure provide a method for wireless communication utilizing coordinated communication, such as coordinated beamforming (CoBF). According to certain aspects, an apparatus (e.g., an AP or non-AP STA) obtains a first frame that includes a preamble, said preamble having: at least one common portion applicable to a first basic service set (BSS) and a second BSS, wherein the first wireless node is associated with the first BSS, one or more user-specific portions, an indication that the first frame is part of a coordinated communication scheme involving the first BSS and the second BSS, and information that identifies the first BSS and the second BSS; and processes the one or more user-specific portions, based on the indication and the information.

### CROSS-REFERENCE TO RELATED APPLICATIONS

This application claims benefit of and priority to U.S. Provisional Application No. 63/690,712, filed Sep. 4, 2024, and U.S. Provisional Application No. 63/710,558, filed Oct. 22, 2024, which are both assigned to the assignee hereof and hereby expressly incorporated by reference in their entireties as if fully set forth below and for all applicable purposes.

### TECHNICAL FIELD

This disclosure relates generally to wireless communication, and more specifically, to coordinated communication, such as coordinated beamforming (CoBF).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

One innovative aspect of the subject matter described in this disclosure can be implemented in a method for wireless communication at a wireless node. The method includes obtaining a first frame that includes a preamble, said preamble having: at least one common portion applicable to a first basic service set (BSS) and a second BSS, wherein the apparatus is associated with the first BSS, one or more user-specific portions, an indication that the first frame is part of a coordinated communication scheme involving the first BSS and the second BSS, and information that identifies the first BSS and the second BSS; and processing the one or more user-specific portions, based on the indication and the information.

Another innovative aspect of the subject matter described in this disclosure can be implemented in a method for wireless communication at a wireless node. The method includes generating a first frame that includes a preamble, said preamble having: at least one common portion applicable to a first basic service set (BSS) and a second BSS, wherein the apparatus is associated with the first BSS, one or more user-specific portions, an indication that the first frame is part of a coordinated communication scheme involving the first BSS and the second BSS, and information that identifies the first BSS and the second BSS; and outputting the first frame.

Another innovative aspect of the subject matter described in this disclosure can be implemented in a method for wireless communication at a wireless node. The method includes obtaining a first frame that triggers a sounding procedure to be performed as part of a coordinated communication scheme involving a first BSS and a second BSS, wherein the wireless node is associated with the second BSS; performing pre-processing of a second frame after obtaining the first frame; and outputting the pre-processed second frame as part of the sounding procedure.

Another innovative aspect of the subject matter described in this disclosure can be implemented in a method for wireless communication at a third wireless node. The method includes obtaining a first frame that triggers a sounding procedure and includes information indicating that the sounding procedure is to be performed according to a coordinated communication scheme involving a first wireless node associated with a first BSS and a second wireless node associated with a second BSS, wherein the third wireless node is associated with the first BSS; obtaining one or more second frames, as part of the sounding procedure, via a quantity of receive antennas, wherein the quantity of received antennas is based on the information included in the first frame; generating CSI feedback, based on the one or more second frames; and providing the CSI feedback to at least the first wireless node.

Another innovative aspect of the subject matter described in this disclosure can be implemented in a method for wireless communication at a first wireless node. The method includes outputting a first frame as part of a coordinated communication scheme involving the first wireless node, which is associated with a first BSS, and a second wireless node associated with a second BSS, wherein the first frame includes an indication of a first bandwidth used by the first wireless node and a second bandwidth used by the second wireless node; and outputting one or more second frames on the first bandwidth.

Another innovative aspect of the subject matter described in this disclosure can be implemented in a method for wireless communication at a first wireless node. The method includes obtaining information associated with a performance metric target for a second wireless node, wherein the first wireless node is associated with a first BSS and the second wireless node associated with a second BSS; and outputting a first frame according to a coordinated communication scheme involving the first wireless node and the second wireless node, wherein a transmission power of the first frame is based on the performance metric target for the second wireless node.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIGS. 4 and 5 show pictorial diagrams of example wireless communication networks, in which coordinated beamforming (CoBF) may be utilized.

FIGS. 6A, 6B, and 7 show example timing diagrams for channel state information (CSI) feedback for CoBF.

FIG. 8 shows an example diagram of sounding and CSI feedback for CoBF, in accordance with aspects of the present disclosure.

FIG. 9 shows an example preamble structure for a CoBF transmission, in accordance with aspects of the present disclosure.

FIGS. 10 and 11 show example fields/subfields that may be used to signal CoBF transmissions, in accordance with aspects of the present disclosure.

FIGS. 12, 13, 14, and 15 show example timing diagrams for CoBF transmissions, in accordance with aspects of the present disclosure.

FIGS. 16, 17, 18, 19, 20, and 21 show flowcharts illustrating example processes performable by or at a wireless node, in accordance with aspects of the present disclosure.

FIG. 22 shows a block diagram of an example wireless communication device

Like reference numbers and designations in the various drawings indicate like elements.

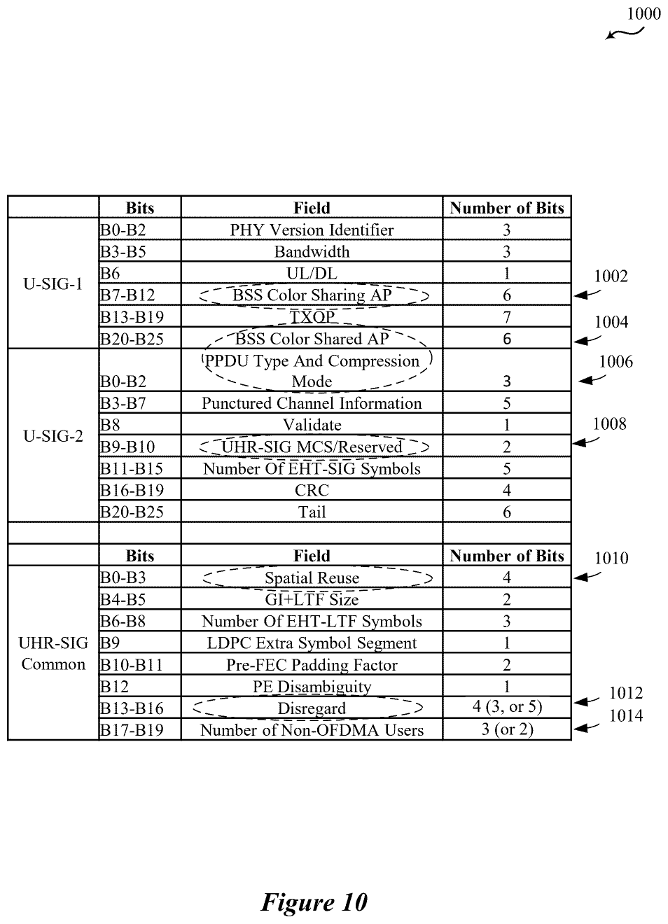

The Appendix includes additional details of example embodiments. For example, the format and description of the table shown in the Appendix may be an alternative to the format of the table shown in FIG. 10.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

In order to address the issue of increasing bandwidth requirements that are demanded for wireless communication systems, different schemes are being developed to allow multiple user terminals to communicate with a single access point (AP) or multiple APs by sharing the channel resources while achieving high data throughputs. Multiple Input Multiple Output (MIMO) technology represents one such approach that has recently emerged as a popular technique for the next generation communication systems.

A MIMO system employs multiple (N_{T}) transmit antennas and multiple (NR) receive antennas for data transmission. A MIMO channel formed by the N_{T} transmit and NR receive antennas may be decomposed into NS independent channels, which are also referred to as spatial channels, where N_{S}≤min{N_{T}, N_{R}} Each of the NS independent channels corresponds to a dimension. The MIMO system can provide improved performance (such as higher throughput and greater reliability) if the additional dimensionalities created by the multiple transmit and receive antennas are utilized.

In wireless networks with multiple APs and multiple user stations (STAs), concurrent transmissions may occur on multiple channels toward different STAs, both in uplink and downlink directions. Many challenges are present in such systems. For example, the AP may transmit signals using different standards. A receiver STA may be able to detect a transmission mode of the signal based on information included in a preamble of the transmission packet.

A downlink multi-user MIMO (MU-MIMO) system based on Spatial Division Multiple Access (SDMA) transmission can simultaneously serve a plurality of spatially separated STAs by applying beamforming at the AP's antenna array. Complex transmit precoding weights can be calculated by the AP based on channel state information (CSI) received from each of the supported STAs.

In a distributed MU-MIMO system, multiple APs may simultaneously serve a plurality of spatially separated STAs by coordinating beamforming by the antennas of the multiple APs. For example, in systems utilizing such coordinated beamforming (CoBF), multiple APs may coordinate transmissions to each STA in an effort to mitigate interference to each other's STAs.

In CoBF, an AP of one basic service set (BSS) may obtain channel state information (CSI) from non-AP STAs of an overlapping BSS (OBSS) in order to mitigate interference (e.g., by forming nulls) to the STA(s). This may involve cross-BSS sounding and CSI feedback from non-AP STA(s) to OBSS AP(s). Each AP may also obtain CSI from its own BSS non-AP STA(s) for forming beams to the STA(s).

Various aspects of the present disclosure provide various mechanisms for performing sounding, CSI processing, and feedback for CoBF. According to certain aspects, processing performed at the non-AP STAs when generating CSI-FB may help optimize CSI processing at the APs.

Particular aspects of the subject matter described in this disclosure can be implemented to realize one or more of the following potential advantages. In some examples, CSI feedback and corresponding processing proposed herein may help enhance CoBF, which may help improve interference mitigation, spectral efficiency, and overall system network performance.

### Example Wireless Communication Network

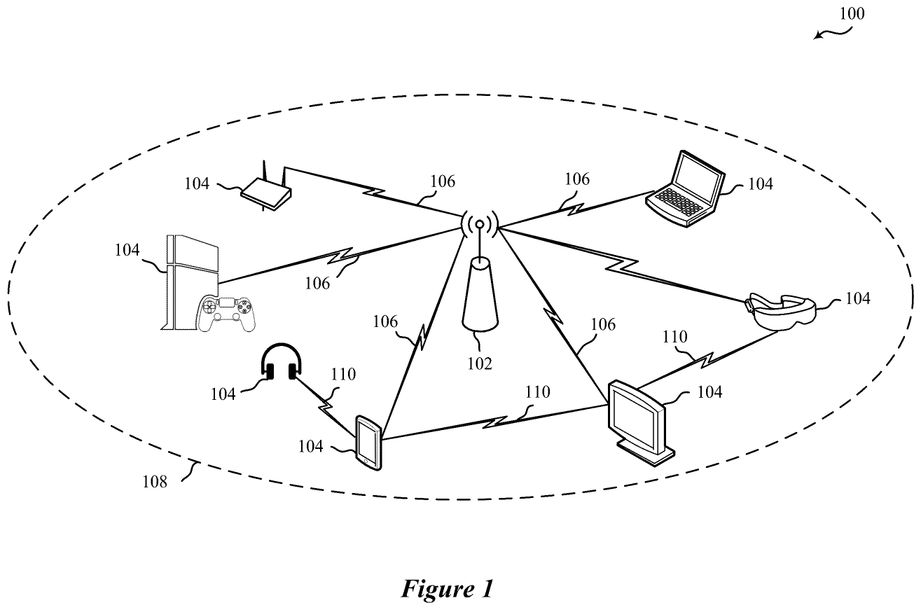

FIG. 1 shows a pictorial diagram of an example wireless communication network 100. The wireless communication network 100 includes various wireless nodes (such as AP STAs and non-AP STAs). According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (CNB), a gNB, a transmission reception point (TRP) or another type of device or equipment included in a radio access network (RAN), including Open-RAN (O-RAN) network entities, such as a central unit (CU), a distributed unit (DU) or an O-RAN radio unit (O-RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IOT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHZ), FR3 (7.125 GHZ-24.25 GHZ), FR4a or FR4-1 (52.6 GHZ-71 GHZ), FR4 (52.6 GHz-114.25 GHZ), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHZ, 160 MHZ, 240 MHz, 320 MHz, 480 MHz, or 640 MHz by bonding together multiple 20 MHz channels.

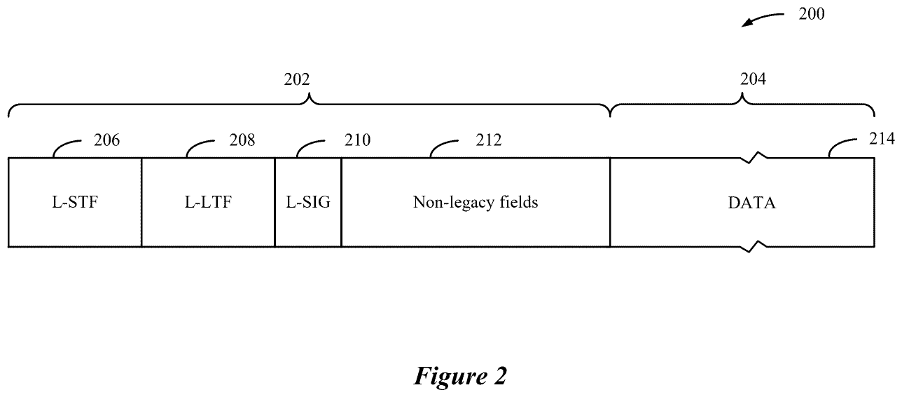

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

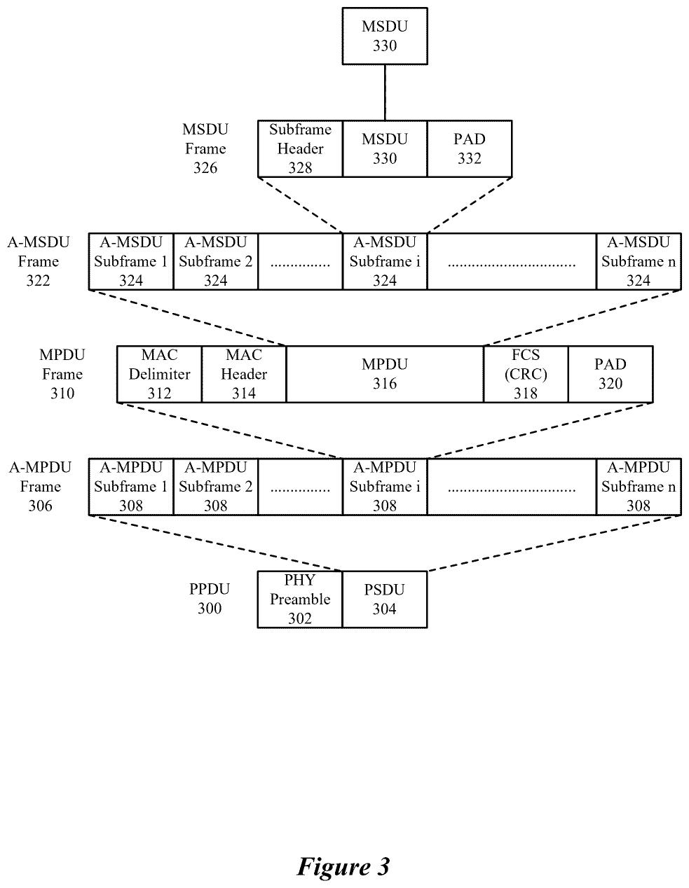

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs) 316. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

### Example Coordinated Communications

In downlink (DL) multi-user multiple-input-multiple-output (MU-MIMO), multiple stations may belong to one basic service set (BSS) transmitting in the DL. Other BSSs (OBSSs) within “hearing” range may defer (not transmit on the medium) in response to detecting an on-going transmission. Different BSSs in hearing range of each other may use time-divisional multiplexing (TDM) to transmit in the DL. In coordinated UL MU-MIMO, multiple BSSs carry out simultaneous UL transmissions. Un-used receive spatial dimensions at the AP may be used to null the interference from the other BSS (OBSS) transmissions. This enables a greater degree of spatial multiplexing when there are un-used spatial dimension within the BSS. In other words, the un-used spatial dimensions may allow for concurrent OBSS transmissions in DL.

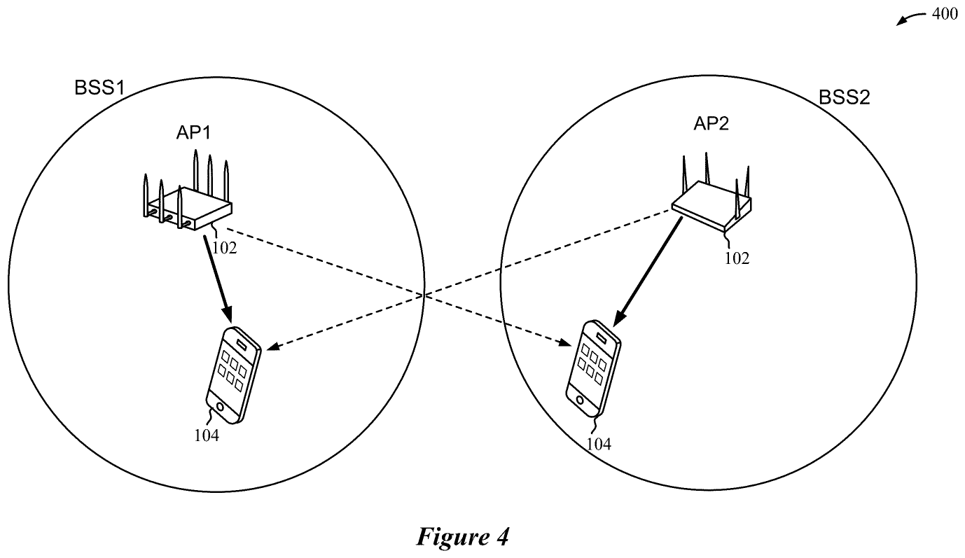

FIG. 4 illustrates a communication system 400 using coordinated DL MU-MIMO, in accordance with certain aspects of the present disclosure. As illustrated, the signal from each AP 102 is transmitted to only stations within their respective BSSs, as shown by the solid lines representing data transmissions from the AP the STAs 104 that are associated with the AP. The data transmissions from the APs cause interference to the other OBSS stations, as illustrated by the dotted lines. Un-used dimensions at the AP may be used to get rid of (e.g., null out) interference from OBSS APS.

In uplink (UL) multi-user multiple-input-multiple-output (MU-MIMO), multiple stations belonging to one BSS may transmit in the UL. Other BSSs within range may defer to an on-going transmission. Different BSSs in range of each other may use time-divisional multiplexing (TDM) to transmit in the UL. In coordinated UL MU-MIMO, multiple BSSs carry out simultaneous UL transmissions. As with DL MU-MIMO, un-used receive spatial dimensions at an AP may be used to null the interference from the other BSS (OBSS) transmissions, enabling a greater degree of spatial multiplexing and allowing for concurrent OBSS transmissions.

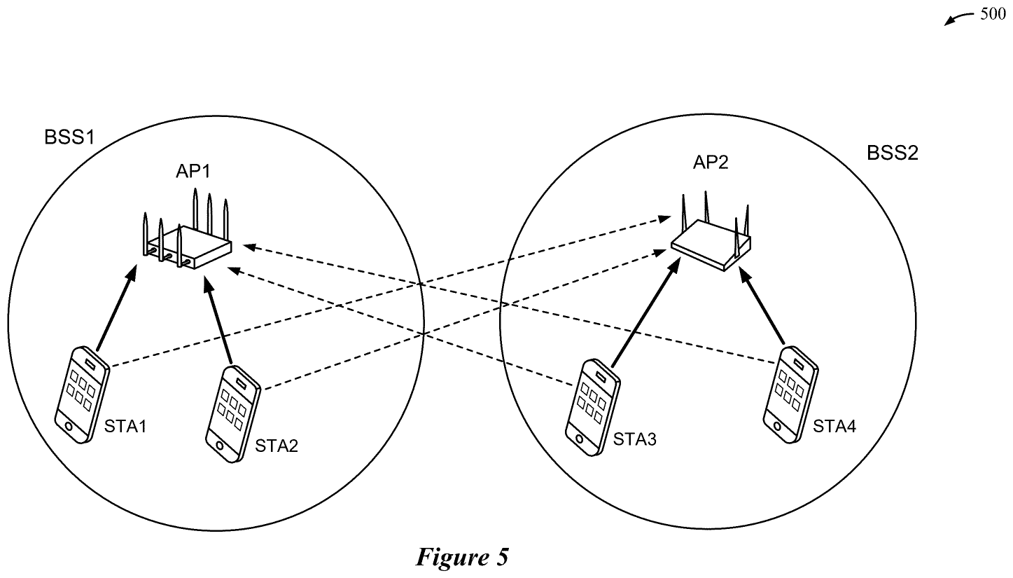

FIG. 5 illustrates an example system 500 that may utilize coordinated UL MU-MIMO. As illustrated, the signal from each STA 104 may be transmitted to only one AP 102 within their respective BSSs, as shown by the solid lines representing data transmissions to the AP the STAs are associated with. The data transmissions from the STAs cause interference to the other OBSS APs, as illustrated by the dotted lines. Un-used spatial dimensions at each AP may be used to mitigate (e.g., reduce or null out) interference from OBSS STAs.

Coordinated beamforming (CoBF) may include one or more protocols for coordinating (e.g., synchronizing) transmissions from different entities, for example, to form nulls to control interference to STAs of other OBSS, while transmitting to own (BSS) STAs.

### Overview of Basic Service Set (Bss) Color

According to certain wireless communications standards (e.g., IEEE 802.11 802.11ax/Wi-Fi 6), the concept of Basic Service Set (BSS) color has been developed as a mechanism to improve network efficiency in dense deployment environments. A Basic Service Set (BSS) refers to a group of wireless devices that are associated with a single access point (AP), using the same service set identifier (SSID) and operating on a common channel. In many real-world scenarios, particularly in environments such as apartment complexes or office buildings, multiple BSSs often operate on the same frequency channel, creating challenges related to interference and channel access contention.

To address these issues, BSS coloring techniques may be employed, where each BSS is assigned a unique identifier known as a “color” (e.g., a numeric value in the range of 0 to 63 (represented using 6 bits)), which may be broadcast in the High Efficiency (HE) frame preamble. This identifier enables devices to distinguish between transmissions originating from their own BSS and those from an overlapping BSS (OBSS).

BSS color supports several key mechanisms aimed at improving spatial reuse and reducing unnecessary deferrals caused by overlapping transmissions. One such mechanism is Overlapping BSS Packet Detection (OBSS-PD), which enables a device to apply a higher energy detection threshold when evaluating whether a detected transmission belongs to an OBSS. If the signal strength of the OBSS transmission is below this threshold, the device may proceed with its own transmission if it will not cause harmful interference. This facilitates simultaneous use of the channel by multiple BSSs and enhances spectrum utilization.

BSS coloring also plays a critical role in enabling spatial reuse (SR), whereby devices are allowed to transmit more aggressively in OBSS scenarios, provided certain conditions are met. This capability significantly increases overall throughput and efficiency in high-density environments.

Additionally, to mitigate situations where multiple BSSs may inadvertently be assigned the same color (e.g., potentially leading to misidentification and interference) dynamic BSS color changes may be employed. For example, APs may detect conflicts and initiate color changes to maintain reliable differentiation between BSSs operating on the same channel.

Utilization of such BSS coloring techniques may enable devices to make more informed medium access decisions, reduce unnecessary contention, and support higher spatial reuse. By allowing more precise identification of overlapping transmissions, this mechanism enhances performance and reliability, particularly in dense deployment scenarios where efficient spectrum usage may be particularly important.

### Example Coordinated Beamformaing

As previously described, in CoBF, multiple APs may coordinate to suppress OBSS interference in the spatial domain. As such, CoBF typically provides gains in an opportunistic manner, for example, when in-BSS transmissions are not fully utilizing that BSS AP's spatial dimensions.

There are various types of CoBF, such as symmetric CoBF with synchronized or asynchronized transmission and asymmetric CoBF with synchronized or asynchronized transmission. With symmetric CoBF, all APs may participate in coordinated beamforming and to suppress their obsess interference to other victim STAs within other BSSs. With asymmetric CoBF, one device (or set of devices) may have higher or lower priority than other devices and/or may lack the capability to suppress OBSS interference.

In general, there can be multiple APs participating in CoBF. To facilitate understanding, however, example techniques will be described herein with reference to a CoBF scenario involving 2 APs. The techniques described herein may be extended to systems involving any number of APs.

The techniques described herein involve various processing for sounding and CSI feedback in CoBF. The techniques described herein may be applied to symmetric CoBF and asymmetric CoBF. As described above, in CoBF, an AP may obtain CSI from OBSS non-AP STA(s) to form nulls to the STA(s). This may involve cross BSS sounding and CSI feedback from non-AP STA(s) to OBSS AP(s). Each AP may also obtain CSI from its own serving non-AP STA(s) to form beams to those STA(s)

In asymmetric CoBF, sounding may involve transmission of just one packet, such as a null data packet (NDP), from a secondary AP to primary recipient. In symmetric CoBF, each AP may send out an NDP to sound the intended and interfering channels. In this context, sounding generally refers to a mechanism used to gather information about the characteristics of a communication channel, in order to optimize transmission parameters to improve the overall performance of CoBF. Sounding typically involves sending specific probe frames or signals and then analyzing the responses that provide CSI feedback, to understand the channel behavior.

There are various options for sounding, for example, involving sending out NDPs to solicit CSI feedback for intended and interfering channels. In this context, an intended channel may refer to a channel between an AP and a non-AP STA served by that AP (in a same BSS), while an interfering channel may refer to a channel between an OBSS AP and a non-AP STA.

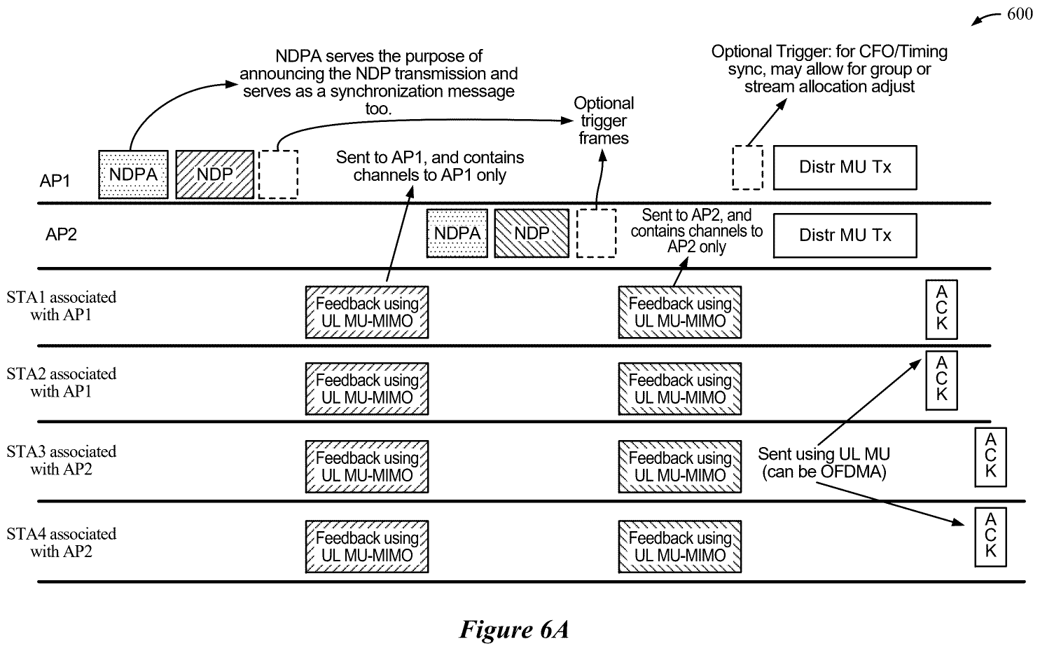

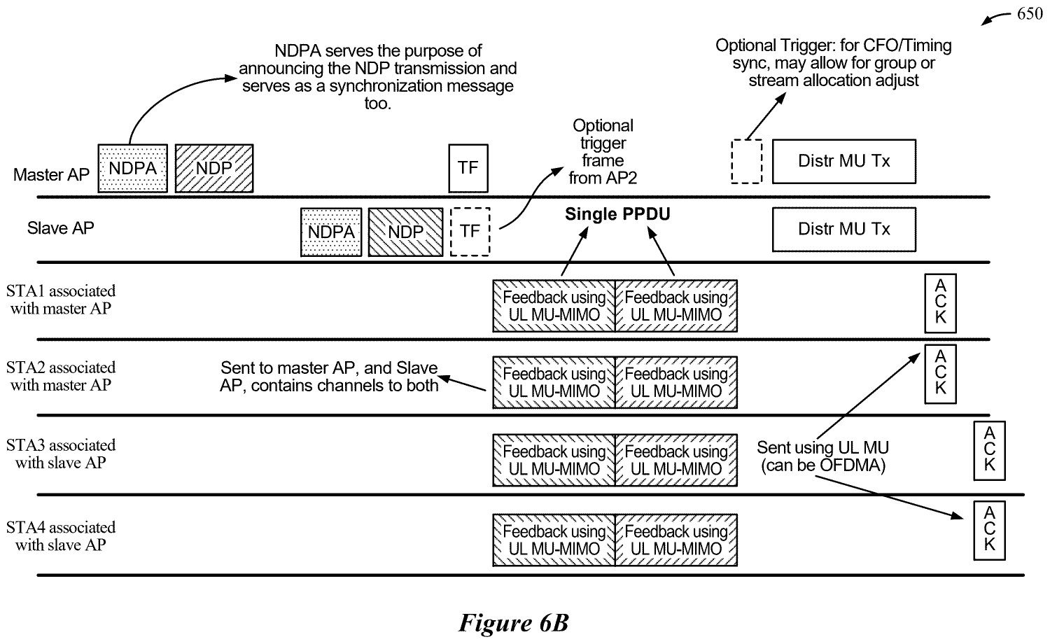

According to a first option, as illustrated in diagram 600 of FIG. 6A, each AP sends one NDP to intended and victim STAs, in a sequential manner.

In such cases, the BSS color of the AP may be included in the NDP so each STAs knows from which AP the NDP (and estimated channel) comes from. In the illustrated example, two APs (e.g., AP1 and AP2 of FIG. 5) send sequential NDPs. Based on the NDP sent from the j-th AP, each STA (the i-th STA) estimates the channel, Hᵢⱼ, channel matrix from j-th AP to the i-th STA.

As illustrated in diagram 650 of FIG. 6B, in some cases, non-AP STAs may not send CSI feedback until after all NDPs are sent and all channels are estimated.

In the illustrated example, AP1 send an NDPA and NDP, then AP2 sends an NDPA and NDP. AP1 sends a Trigger frame (TF) and at the same time AP2 may send an optional TF, triggering the STAs to send CSI feedback to both APs. To generate the CSI feedback, the non-AP STAs could use the enhanced CSI processing and small V feedback techniques described herein. The non-AP STAs could also use the large V feedback of the composite channels, provided the phase and automatic gain control (AGC) at each non-AP STAs use the same phase and AGC setting when processing all of NDP packets.

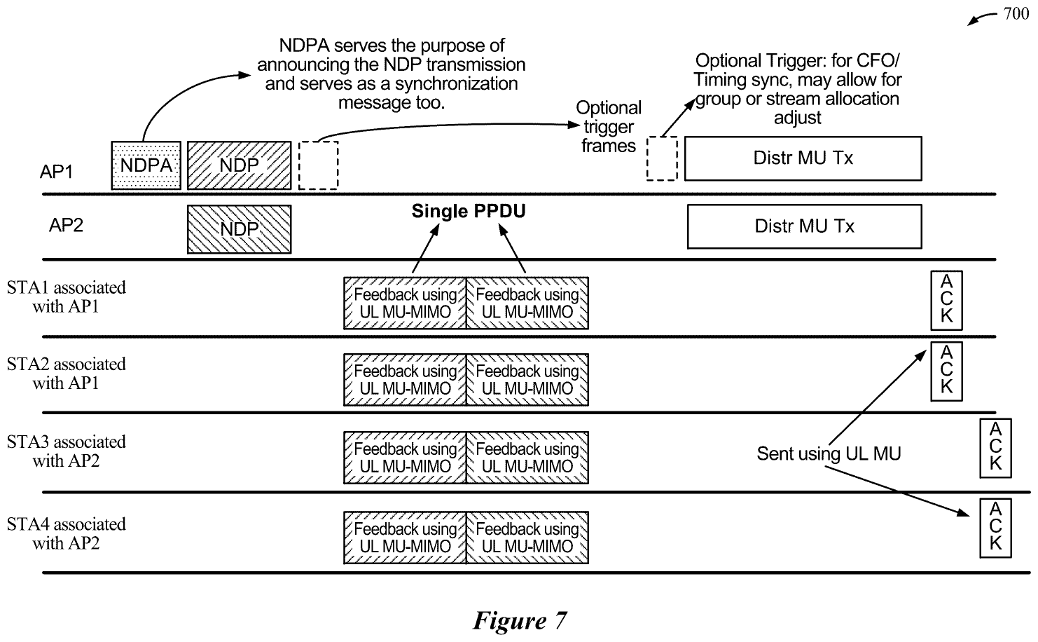

According to a second option, as illustrated in diagram 700 of FIG. 7, APs participating in CoBF collaboratively send out a joint NDP to all serving STAs. The NDP may be considered a joint NDP, even though it is sent from two different APs.

In this context, a joint NDP may be one PPDU sent from both APs, with identical information (transmitted by each AP) in all fields except in a long training field (e.g., a UHR-LTF) field. In the LTF, each AP may send different streams and the streams sent from different APs may use mutually different indices. In this manner, all APs may share a joint LTF, where the first subset of streams are sent from 1st AP, and second subset of streams are sent from a 2nd AP, so that the estimated channel is a composite channel where first subset of streams are from 1st AP and second subset of streams are from 2nd AP.

The joint NDP may use a group BSS color for the group of CoBF APs. The group BSS color may be sent in a prior packet, such as an NDP announcement (NDPA) frame from one of the APs (e.g., a sharing AP), before the joint NDP. In this context, an AP that owns a transmit opportunity (TXOP) may be referred to as a sharing AP, while another AP participating in the coordinated communication in the TXOP may be referred to as a shared AP.

According to certain aspects of the present disclosure, to aid in CSI processing by a non-AP STA, a joint NDP may indicate which part of composite channel comes from which AP. For example, the joint NDP (or some other signaling mechanism) may signal the numbers of Tx antennas or streams from different APs, i.e., [N_tx_1, N_tx_2, . . . ] or [N_ss_1, N_ss_2, . . . ] and the list of CoBF BSS IDs in NDPA, so that STAs know which part of composite channel comes from intended AP and which part comes from interfering AP(s). Alternatively, the joint NDP (or some other signaling mechanism) may signal the starting stream indices for different APs and the list of CoBF BSS IDs in NDPA. If the numbers of Tx antennas or streams from different APs or the start stream indices for different APs are signaled, they may be in a prior packet, e.g., NDPA, or in the joint NDP packet (e.g., in U-SIG or the common field of the UHR-SIG).

With joint sounding, each STA (the i-th STA) may estimate the composite channel matrix at from Nₐₚ APs as Hᵢ=[Hᵢ₁ Hᵢ₂ . . . . H_{iN}_{ₐₚ}], where each Hᵢⱼ represents a channel matrix for a channel between STAi and APj. Joint NDP may have less overhead, and may help with enhanced coordinated spatial reuse (CSR) and/or joint transmission (JT) to a single or multiple STAs.

Aspects of the present disclosure also provide various options for sending CSI feedback, including cross-BSS CSI feedback. In some cases, a backhaul (e.g., a light backhaul) between APs may be used for CSI exchange. In such cases, all STAs may send CSI feedbacks to their own APs and the APs may share with each other (exchanging CSI feedback) over the backhaul. In this case, UL transmissions (of CSI-FB) to own APs may be done in parallel, for example, if using coordinated UL MU-MIMO or coordinated UL OFDMA.

In some cases, if there is no backhaul, it may be assumed that coordinated UL MU-MIMO is used. In such cases, STAs may transmit to their own APs in parallel, then the STAs may transmit to OBSS in APs in parallel. In other cases, coordinated UL MU-MIMO may not be assumed, though this may mean both APs do not receive simultaneously and, hence, may have additional latency for each STA to feedback to all the APs one at a time.

In some cases, coordinated UL MU-MIMO may involve CoBF, with un-utilized spatial dimensions of the AP used to perform receive (Rx) nulling of OBSS UL transmissions.

Aspects of the present disclosure provide various options that may be applied in both point-to-point channel CSI processing and feedback and composite channel CSI processing and feedback.

In this context, point-to-point channel feedback generally refers to the CSI feedback of a channel between two STAs, such as an AP and a non-AP STA (e.g., with a channel matrix Hᵢⱼ for APj and STAi). For point-to-point channel feedback, there are also various sub-options with different types of CSI processing (e.g., to generate the CSI feedback) and different types of content fed back (e.g., as CSI feedback).

A composite channel may be either point to multi-point (e.g., from one AP to multiple non-AP STAs) or multi-point to single point (e.g., from multiple APs to a single STA). In this context, composite channel feedback generally refers to the CSI feedback of a composite channel, such as the channel from multiple APs (e.g., an in-BSS and OBSS AP) to a single STA (Hᵢ). As will be described below with reference to FIG. 10, aspects of the present disclosure provide techniques for a non-AP STA to generate composite channel CSI feedback and for an AP to reconstruct point-to-point channel CSI from the composite channel CSI feedback.

Point-to-point Channel CSI processing and feedback may be performed as follows. An N_{rx,i}×N_{tx,j} channel matrix from a j-th AP (APj) to an i-th STA (STAi) may be denoted as Hᵢⱼ where N_{rx,i} is the number of receive antennas of APj and N_{tx,j} is the number of transmit antennas from APj (and N_{rx,i}≤N_{tx,j}).

Based on the channel estimation of a packet (e.g., an NDP) from APj, STAi may obtain the channel matrix Hu, and perform a singular value decomposition (SVD) on Hᵢⱼ to obtain:

$${H}_{ij} = {U}_{ij} \cdot {S}_{ij} \cdot {V}_{ij}^{′} ,$$

where Uᵢⱼ is an N_{rx,i}×N_{rx,i} (left semi-unitary or) unitary matrix, Sᵢⱼ is an N_{rx,i}×N_{rx,i} diagonal matrix with the singular values of the channel Hᵢⱼ, and Vᵢ is an N_{tx,j}×N_{rx,i} (right) semi-unitary (or unitary) matrix.

In some cases, CSI feedback may be what is referred to as small V feedback. With small V feedback, STAi feeds back Sᵢⱼ and Vᵢⱼ of requested rank N_{fb,i}, i.e., S_{fb,ij}=Sᵢⱼ(1:N_{fb,i}, 1:N_{fb,i}) and V_{fb,ij}=Vᵢⱼ (:, 1: N_{fb,i}), where the requested rank may be signaled to the STA in a prior packet, e.g., NDPA. The notation of A(i:j, k:1) represents a submatrix of A, by selecting from the i-th to j-th rows and from the k-th to 1-th columns. The notation “:” in a submatrix A(:, k: 1) represents a submatrix of A, by selecting all rows and from the k-th to 1-th columns. Likewise, the notation “:” in a submatrix A(i:j,:) represents a submatrix of A, by selecting from the i-th to j-th rows and all columns. In this manner, an AP may request CSI feedback (of certain matrices) to be of a certain rank (or number of columns). For example, an SVD may produce 4 Eigen channels, but the AP may only request a rank of 2 or 3 in a CSI feedback request.

In the case of small V feedback, the reconstructed channel

$${rH}_{ij} = {S}_{fb , ij} \cdot {V}_{fb , ij}^{′}$$

corresponds to the Eigen channels using the

$${U}_{nfb , ij}^{′}$$

receiver (e.g., which is not fed back), where U_{nfb,ij}=Uᵢⱼ (:, 1: N_{fb,i}). In this case, the full channel Hᵢⱼ may not be reconstructed, which may result in less than optimal CoBF.

According to one of the sub-options presented herein, however, STAi may use a CSI processing technique for the small V feedback of the intended and interfering channels based on the same receiver.

One example of this first sub-option for point-to-point channel CSI processing and feedback may assume AP1 (BSS1) and AP2 (BSS2) transmit NDP(s) for sounding. In such cases, STA1 may generate, based on the NDP(s), CSI FB for an intended channel (between AP1 and STA1) based on an SVD of an original channel and may generate CSI FB for an interfering channel (between AP2 and STA1) based on an SVD of an equivalent channel.

In some cases, STA1 may provide this (enhanced small V) CSI-FB to AP1. In some cases, STA1 may also provide this CSI-FB directly to AP2. In other cases, AP1 and AP2 may exchange CSI-FB (e.g., if a backhaul exists). For example, AP1 may transmit the CSI-FB for the interfering channel (between AP2 and STA1) to AP2 via a light backhaul. While not shown, STA2 may also generate CSI-FB for its intended channel (between AP2 and STA2) and interfering channel (between AP1 and STA2) and provide this CSI-FB to at least its AP (AP2).

This enhanced CSI processing for small V feedback according to this first sub-option may be described as follows, assuming the i-th AP is the serving AP of the i-th STA so that Hit is an intended channel and all other Hᵢⱼ where j≠i are interfering channels.

For intended channel Hᵢⱼ, STAi may feed back S_{fb,ii}=Sᵢᵢ(1:N_{fb,i}, 1:N_{fb,i}) and V_{fb,ii}=Vᵢᵢ(:, 1: N_{fb,i}) where N_{fb,i}=N_{ss,i}, where N_{ss,i} is the number of streams for the i-th STA that the i-AP intended to send in the CoBFed transmission, assuming using the Eigen receiver

$${U}_{ss , ii}^{′}$$

(e.g., which is not fed back) where U_{ss,ii}=Uᵢᵢ(:, 1: N_{ss,i}).

For interfering channel Hᵢⱼ where ≠i, the equivalent channel assuming the Eigen receiver at the i-th STA is

$${U}_{ss , ii}^{′}$$

so that the equivalent channel from the j-th AP to the i-th STA after this Eigen receiver processing becomes

$${U}_{ss , ii}^{′} {H}_{ij} .$$

For the CSI FB for the interfering channel, STAi may perform SVD on the equivalent channel

$${U}_{ss , ii}^{′} {H}_{ij}$$

obtain:

$${U}_{ss , ii}^{′} {H}_{ij} = {U}_{ss , ij} \cdot {S}_{ss , ij} \cdot {V}_{ss , ij}^{′} ,$$

where U_{ss,ij} is an N_{ss,i}×N_{ss,i} unitary matrix, S_{ss,ij} is an N_{ss,i}×N_{ss,i} diagonal matrix with the singular values of the equivalent channel

$${U}_{ss , ii}^{′} {H}_{ij} ,$$

and V_{ss,i} is an N_{tx,j}×N_{ss,i} semi-unitary matrix. Feedback S_{fb,ij}=S_{ss,ij}(1: N_{fb,i}, 1: N_{fb,i}) and V_{fb,ij}=V_{ss,ij}(:, 1: N_{fb,i}) where N_{fb,i}=N_{ss,i}.

A distinction between the enhanced small V feedback according to this first sub-option and typical V feedback is that the enhanced feedback (e.g., further interfering channels) is based on the SVD of the equivalent channel

$${U}_{ss , ii}^{′} {H}_{ij}$$

instead of the SVD of the original channel Hᵢⱼ. In this way, the same receiver

$${U}_{ss , ii}^{′}$$

is an assumed for intended and interfering channels. In this example, it is assumed that the Eigen receiver

$${U}_{ss , ii}^{′}$$

is used to generate both the CSI FB for the intended channel Hu and the CSI FB for the interfering equivalent channel

$${U}_{ss , ii}^{′} .$$

A more general case in the enhanced feedback is to use a same linear receiver Gᵢ to generate both the CSI FB for the intended equivalent channel GᵢHᵢᵢ and the CSI FB for the interfering equivalent channel GᵢHᵢⱼ.

According to another of the sub-options presented herein, however, STAi may feedback U, S, and V from the SVD of the point-to-point channel. For example, STAi may feed back Uᵢⱼ, Sᵢⱼ and Vᵢⱼ of a requested rank N_{fb,i}, i.e., U_{nfb,ij} (e.g., which is fed back in this case), S_{fb,ij} and V_{fb,ij}.

In some cases, it may be beneficial to exchange certain information that may be needed for joint NDP via NDPA. In some cases, a STA information (info) field may include a special AID value for a shared AP. In some cases, a sounding dialogue token reserved state might be used to signal that this is a NDPA that signals joint sounding. Such an indication may indicate to an AP (e.g., and possibly the STAs) that a joint sounding NDP is going to arrive.

In some cases, such information may be conveyed via a single STA info field. Such a field may be considered a special STA Info Field targeted to an AP in NDPA preceding a joint NDP. In some cases, the special STA1D per AP can be advertised in the beacon as some form of AP identifier (e.g., which may be a self-chosen IP, referred to as a “CoBF special APID). Collisions may be resolved in a similar manner as BSS color collisions. In some cases, the CoBF special APID may be 11 bits.

For CoBF sounding, an NDPA may still being addressed to an in-BSS STA. There may be no need for changes to a BSS ID (transmitter of the NDPA) and STA1D in the STA info field to the target STA. Other information may be conveyed, such as the number of streams (e.g., columns) being requested in the feedback is Nc. In some cases, a special STA info field may be addressed to a shared AP. This field may convey the starting and ending stream index for the shared AP and may convey information regarding what rows of the P-matrix to use. The STA info field may use a special AID which is associated with the AP.

In some cases, asymmetric CoBF may be supported, for example, with two 4 Tx APs, each having one active STA. Such an example may assume a secondary BSS has a 2Rx STA and secondary AP intends to transmit 1ss to that station. The example may also assume that the primary STA is explicitly sounded to secondary AP channel and that the primary STA pre-calculates the optimum receive filter and pre-compensates the interference channel feedback to the interfering AP (e.g., to provide a single Eigen mode where interference needs to be nulled).

Various potential issues related to asymmetric CoBF may be addressed. Such issues may be explained considering an example that assumes a 2Rx STA in the primary BSS. In one case, the STA may be receiving 1ss and feeds back a single Eigen mode to secondary BSS. In such cases, there may be joint LTFs, for which we need pre-negotiation of several things between secondary and primary AP. In another case, the STA may receive 2ss. In such cases, 2 Eigen modes may be fed back to the secondary BSS AP.

There are various options for CoBF group formation, in order to determine what APs will participate in CoBF). According to a first option, a sharing AP (e.g., AP1) sends a CoBF opportunity trigger to the APs, an intent to participate, and a final CoBF configuration. The trigger may contain a number of spatial multiplexing dimensions available at sharing AP, a list of APs that AP1 is inviting for CoBF (e.g., AP1 sees them as good CoBF candidates). For example, some STAs in BSS1 may get labeled via a background process as good candidates for CoBF with AP2 and AP3. A trigger may also indicate resources for transmitting an intent to participate. The intent to participate (e.g., transmitted using TB PPDU) may contain a number of spatial multiplexing dimensions (e.g., and/or number of antennas) available at shared AP and indicate to a responding AP (e.g., AP2 and AP3) STAs which are good candidates for CoBF with AP1. The final CoBF configuration may contain an identifier for the AP(s) in 2-AP groups as shared AP(s) for CoBF with sharing AP1.

According to another option for CoBF group formation, every AP may advertise various information in the beacon. Such information may include, for example, spatial multiplexing capability (maybe equal to the number of antennas) for CoBF and a list of good candidate neighboring APs for CoBF. In some cases, this list may get updated in the beacon based on the in-BSS background process. In some cases, there may be no explicit group formation phase. Rather group formation may begin directly with the sounding phase with one AP acting as sharing AP.

There are various options for resolving collisions of CoBF APID with STA1D in the first option described above. For example, if AP2 picks a CoBF APID which matches STA1's ID, various information may be signaled in the NDPA. Such information may include, for example, that the NDP is a UHR variant of NDP and/or is a joint sounding NDP (e.g., via reserved state in sounding dialogue token). Such information may notify the STA1 and AP2 that there is a STA info field that is meant for AP2 at a fixed location (e.g., either the first or the last STA info field in the NDPA). In some cases, the STA may ignore that STA info field even if the STA1D matches.

In some cases, such signaling may also be used by AP2, for example, to determine that an NDPA is a special NDPA, which prompts AP2 to send an NDP in response. The signaling may also notify AP2 that it needs to look for a special STA info field at either the beginning or the end.

### Coordinated Beamforming Indicating and Processing

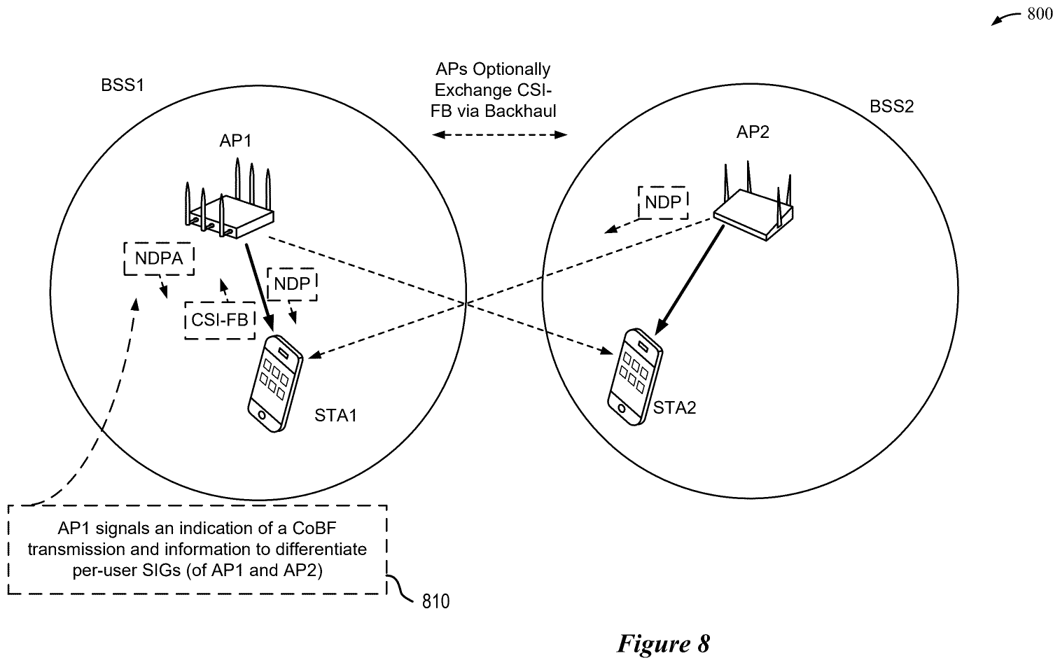

Referring to FIG. 8, an example of CoBF based transmissions, in accordance with aspects of the present disclosure. The example assumes AP1 (BSS1) and AP2 (BSS2) transmit NDP(s) for sounding. As noted at 810, an NDPA from AP1 may signal an indication of a CoBF transmission and information to differentiate per-user SIGs (of AP1 and AP2). For example, the indication may be that the NDPA (and NDPs to follow) are part of a CoBF sounding procedure.

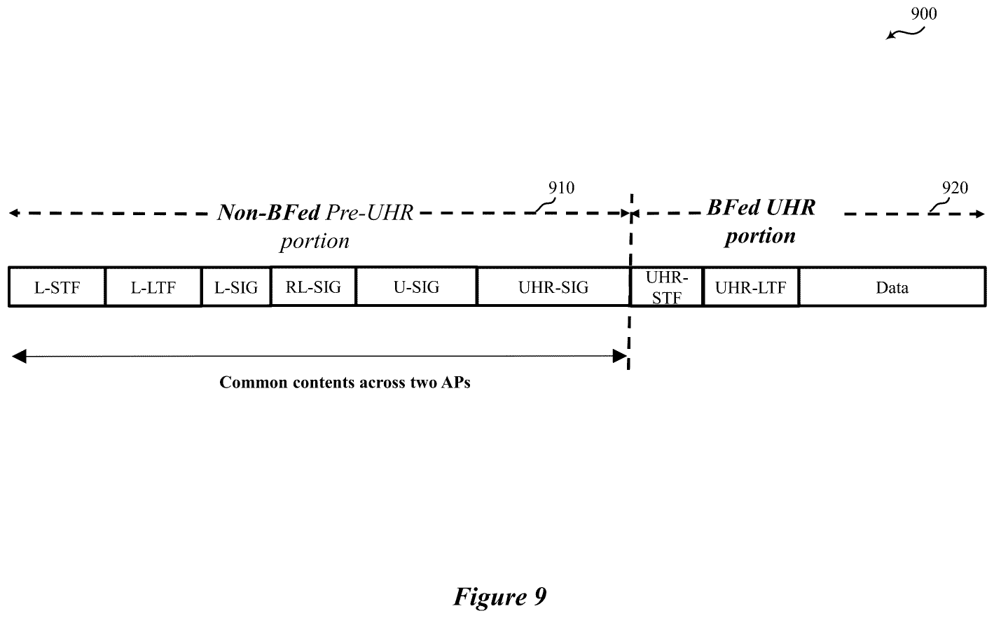

In some cases, the indication may be signaled in a preamble of a coordinated communication (e.g., CoBF) transmission, such as preamble 900 shown in FIG. 9. As illustrated, the preamble 900 may include a first portion 910 that is not beamformed and a second portion 920 that is beamformed. The first portion may be designed to be detectable by devices that support legacy versions of a standard, for example, that precede Ultra High Reliability (UHR) version of a wireless standard (e.g., Wi-Fi 8), while the second portion may be detectable by devices that support UHR.

As indicated, content of the first (pre-UHR) portion may be common across (BSSs of) the two APs participating in CoBF. The pre-UHR portion of the preamble includes the L-STF, L-LTF, L-SIG, RL-SIG, U-SIG and UHR-SIG fields. In this context, common means that the information carried in the pre-UHR portion of preamble of the two PPDUs from the two APs participating in CoBF may be the same. One exception may be that the padding bits (if present) in UHR-SIG may be different between the two PPDUs. Since the padding bits (if present) are outside of any code blocks that carry useful information, different padding bits between the two PPDUs do not impact decoding performance of UHR-SIG. According to certain aspects, the content in the pre-UHR portion may be pre-negotiated (e.g., between APs). For example, such pre-negotiated fields may include BW, BSS color, TXOP duration, UHR-SIG MCS (which may be fixed), a punctured channel indication, GI+LTF size, a number of UHR LTF symbols, and a number of UHR-SIG symbols.

In some cases, the preamble may include per-user SIG fields (though not shown in FIG. 9). Aspects of the present disclosure provide various signaling mechanisms that may allow a device (e.g., a STA) to distinguish between the per-user SIG fields in the preamble.

For example, the coordinated transmission involves two PPDUs sent from two APs that share the common preamble of U-SIG and UHR-SIG. As proposed herein, in U-SIG, both the BSS color of the sharing AP and BSS color the shared AP may be indicated (e.g., in a fixed order). In UHR-SIG, in each user field, there may be a STA ID and a 1-bit BSS color indication (e.g., which may reuse a bit, such as coding bit because CoBF may only use one type of coding) to indicate which BSS it's associated to. In this manner, a STA may learn (from U-SIG) whether it belongs to a BSS involved in the transmission. Because STA IDs may be reused across BSSs, for a STA to identify if a user field in UHR-SIG is intended for it, the STA also needs to know if that user field is for its BSS. Thus, the user field may include both the BSS information and STA ID to uniquely identify one STA.

As noted above, the preamble may include an indication that the transmission is a CoBF transmission. This information may, thus, aid in processing per-user SIG fields by indicating they come from the two APs.

There are various options for differentiating the per-user SIGs of the two APs. For example, BSS IDs, partial BSS IDs, or BSS colors of participating APs may be placed in U-SIG or UHR-SIG-common fields and then a 1-bit field in the per-user SIG field could be used to differentiate between the two APs. In some cases, the 1 bit field can be overloaded with other bits like unequal modulation (UEQM) or coding bits. In some cases, a first BSS color in U-SIG may indicate (a BSS associated with) the sharing AP and a second BSS color in U-SIG may indicate (a BSS associated with) the shared AP for COBF.

For a case in which CoBF is restricted to full bandwidth (BW) operation, the number of users of the sharing AP and/or the shared AP may be signaled in a UHR-SIG-common field, such that the per-user fields belonging to sharing and shared AP can be identified. In some cases, a total number of users across both APs may be conveyed. For example, if AP1 has n1 users and AP2 has n2 users, it may be sufficient to know any two out of n1, n2 or n1+n2.

A number of resources (e.g., fields/sub-fields) may be available to be (repurposed) when the PPDU indicates that it is a CoBF PPDU. For example, there may be a quantity (e.g., 12) of validate/disregard bits in U-SIG and UHR-SIG. In addition, there may be various bits that might not be meaningful for CoBF (e.g., 4 spatial re-use bits). One or more of such bits may be used (e.g., repurposed) when the PPDU carries an indication that it is a CoBF transmission.

For example, FIG. 10 illustrates an example preamble format 1000 in which bits in a BSS color field 1002 may be repurposed to indicate a BSS color of the sharing AP for CoBF transmissions. Similarly, bits previously designated as disregard and validate bits may be repurposed to indicate a BSS color of the shared AP, as indicated at 1004. For example, as in FIG. 10, in a CoBF transmission, bits B7-B12 of U-SIG (and U-SIG-1, which is the first part of U-SIG) may be used to indicate the BSS color of the sharing AP 1002, and bits B20-B25 of U-SIG (and U-SIG-1) may be repurposed from Disregard and Validate bits to indicate the BSS color of the shared AP 1004.

In some cases, whether bits/fields are interpreted as described above, may depend on whether a transmission is a CoBF transmission. For example, whether two BSS colors are indicated in U-SIG as shown in FIG. 10 (and whether a 1-bit BSS flag is indicated in each user field) may be conditioned on if a transmission is a CoBF transmission. In some cases, a CoBF transmission may be so indicated through a combination of bits/fields, such as an UL/DL field, a PPDU Type And Compression Mode field, and a CoBF/CoSR indication field in U-SIG.

In some cases, the CoBF indication may be signaled via a PPDU type and compression mode that is expanded to include 3 bits (e.g., B0-B2) rather than 2 bits (e.g., B0-B1), as indicated at 1006.

As noted above, one of the states in PPDU type and compression mode field 1006 (e.g., expanded to 3 bits) may indicate that this is a COBF transmission. Various other types of SIG field content may be similarly repurposed. For example, as indicated at 1008, a UHR-SIG MCS value may be fixed and, hence, not needed. As indicated at 1010, a spatial re-use field may not be meaningful for CoBF and may, thus, be reduced to a lesser quantity of bits (e.g., reduced from 4 bits to 2 bits) or may be repurposed to convey something else. As indicated at 1012, the quantity of bits in the Disregard field in the UHR-SIG common field may be 3, 4, or 5, so that the total number of bits in the UHR-SIG common field may be 19 bits or 20 bits.

As indicated at 1014, the Number of Non-OFDMA Users subfield may use 2 bits or 3 bits to indicate the total quantity of non-OFDMA users associated with the current CoBF transmission. Alternatively, it may use 2 bits or 3 bits to indicate the combinations of quantity of users associated to the sharing AP that are associated with the current CoBF transmission and the quantity of users associated to the shared AP that are associated with the current CoBF transmission. For example, in a 2-bit design:
a value of 0 may indicate 1 user associated to the sharing AP and 1 user associated to the shared AP are associated with the current CoBF transmission,
a value of 1 may indicate 1 user associated to the sharing AP and 2 users associated to the shared AP are associated with the current CoBF transmission,
a value of 2 may indicate 2 users associated to the sharing AP and 1 user associated to the shared AP are associated with the current CoBF transmission, and
a value of 3 may indicate 2 users associated to the sharing AP and 2 users associated to the shared AP are associated with the current CoBF transmission.

If CoBF is allowed for the partial BW case, various bits may be used to indicate two partial BSS IDs or colors (e.g., as shown in FIG. 10). If CoBF is used for only the full BW cases, the number of users of the sharing AP may be indicated as a separate field. This may allow STAs in both BSSs to know where their per-user-SIG fields begin.

In this manner, when the indication in the preamble is that the PPDU is a CoBF PPDU, various other fields (e.g., subfields/bits) may be repurposed to convey multiple BSSIDs/BSS Colors. This information may be conveyed in various manners. For example, the information may be conveyed as 2 partial BSSIDs/BSS Colors or 2 partial BSSIDs/BSS Colors and one common BSS color. In either case, the BSSIDs/BSS Colors may be used to identify the transmitters of the COBF PPDU. This information may allow STAs to know which is BSS1 and which is BSS2 and may help differentiate/classify the per-user-UHR-SIG fields into own-BSS or OBSS categories.

In some cases, a bit (e.g., 1 bit) may be used to indicate whether the per-user SIG belongs to sharing AP or shared AP (e.g., if the CoBF transmissions are allowed for cases other than full BW). In some cases, the coding scheme may be fixed (e.g., to LDPC) and certain bits (previously used for indicating coding) may be repurposed when CoBF is indicated (e.g., via previous SIG fields).

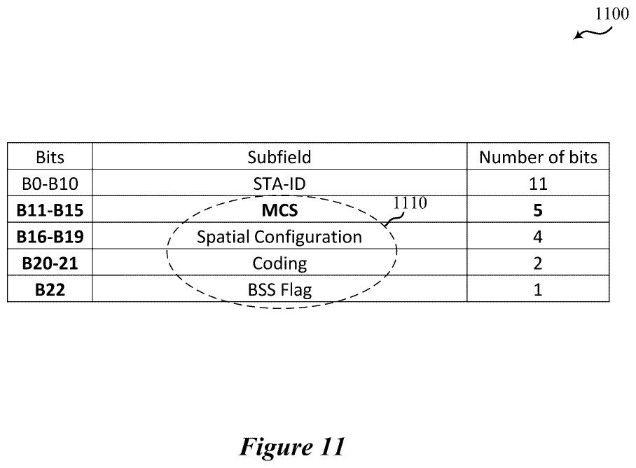

FIG. 11 illustrates an example format 1100 of a user field in which bits of various fields/subfields 1110 may be repurposed. As illustrated, the fields 1110 may include a modulation and coding scheme (MCS), spatial configuration, coding, and BSS flag subfields may be used to convey per-user SIG information. In some cases, the fields 1110 may include a modulation and coding scheme (MCS) subfield, a spatial configuration subfield, a 1-bit coding subfield to differentiate BCC and LDPC, a 1-bit 2× LDPC subfield to differentiate LDPC (e.g., with nominal codeword size no greater than 1944) and LDPC with nominal codeword size of 3888 in the case of LDPC, and a BSS flag subfield may be used to convey per-user SIG information. In some cases, the spatial configuration field may function similar to conventional frameworks, but the stream indices may be according to a global number of streams of the two APs (e.g., and total streams may be limited to 8). In the present context, a subfield generally refers to a field that is part of a larger field. As such, a subfield may also be referred to simply as a field.

As described above, a 1-bit field in an MU-MIMO user field format may be used to indicate a BSS flag, if CoBF is indicated. In some cases, this 1-bit field could be a 1-bit reserved field. This approach may be applicable to both non-OFDMA MU-MIMO transmissions and DL OFDMA transmissions.

In some cases, the 1-bit field may be obtained by repurposing another bit. For example, a 1-bit indication in the per-user SIG field may be used to resolve a BSS color for COBF transmissions (e.g., such a bit may indicate whether the corresponding user field is for a STA in the sharing AP BSS or the shared AP BSS). As one example, in an MU-MIMO user field format, the coding bit (e.g., typically used to differentiate between BCC and LDPC for a non CoBF transmission) may be repurposed for the 1-bit BSS flag. This bit may be suitable for repurposing in this manner, since LDPC is always used for the (M) RU size in CoBF.

As another example, in the non-MU-MIMO user field format, when the 1-bit EQM/UEQM flag indicates the case of spatial domain (SD) equal modulation (EQM), the coding bit (used to differentiate BCC and LDPC) may be re-purposed for the 1-bit BSS flag. On the other hand, when the 1-bit EQM/UEQM flag indicates the case of SD unequal modulation (UEQM), the most significant bit (MSB) of the 3-bit NSS subfield may be repurposed for the 1-bit BSS flag, since only 2-4 SS are used (needing only 2-bits) in SD UEQM.

According to certain aspects, in the resource unit (RU) allocation subfield the (M) RUs with MU-MIMO, 8 values may be used to indicate the number of users (e.g., 1-8 users) being assigned to each (M) RU. In the case of partial bandwidth CoBF in DL OFDMA transmission, the CoBF indication may also indicate which frequency subband has CoBF ON and the remaining frequency subband(s) may be assumed to have CoBF OFF. For example, a total of 2 bits may be used to indicate CoBF ON or OFF with a frequency resolution of half of a PPDU's bandwidth. As an example, one bit may indicate if the lower half PPDU bandwidth has CoBF ON or OFF, and the other bit may indicate if the upper half PPDU bandwidth has CoBF ON or OFF. As another example, one bit may indicate if CoBF is ON or OFF for at least a partial bandwidth, and the other bit may indicate if CoBF is ON in a lower or upper half PPDU bandwidth. The RU allocation subfield encoding for the (M) RUs with MU-MIMO not in the CoBF mode may remain unchanged.

In the RU allocation subfield encoding for the (M) RUs with MU-MIMO in the CoBF mode, the values corresponding to the same (M) RU with MU-MIMO may be used to jointly indicate the number of users (e.g., and user fields) in the sharing BSS and in the shared BSS, as well as the ordering of the user fields (e.g., if the user fields for the sharing BSS are before or after those for the shared BSS). For example, 8 values may be used to indicate different combinations of users [N_user_sharing_BSS, N_user_shared_BSS, the user fields of which BSS are first].

As an example, the 8 values may be:
[1, 1, sharing BSS first] to indicate 1 user field for the sharing BSS followed by 1 user field for the shared BSS,
[1, 2, sharing BSS first] to indicate 1 user field for the sharing BSS followed by 2 user fields for the shared BSS,
[2, 1, sharing BSS first] to indicate 2 user fields for the sharing BSS followed by 1 user field for the shared BSS,
[2, 2, sharing BSS first] to indicate 2 user fields for the sharing BSS followed by 2 user fields for the shared BSS,
[1, 1, shared BSS first] to indicate 1 user field for the shared BSS followed by 1 user field for the sharing BSS,
[1, 2, shared BSS first] to indicate 2 user fields for the shared BSS followed by 1 user field for the sharing BSS,
[2, 1, shared BSS first] to indicate 1 user field for the shared BSS followed by 2 user fields for the sharing BSS, and/or
[2, 2, shared BSS first] to indicate 2 user fields for the shared BSS followed by 2 user fields for the sharing BSS.

As an alternative, the values corresponding to the same (M) RU with MU-MIMO may be used to jointly indicate the combinations of the total number of users (e.g., across both sharing and shared BSSs) and the number of users in the sharing BSS, as well as the ordering of the user fields (e.g., if the user fields for the sharing BSS are before or after those for the shared BSS: [N_total_user_across_two_BSSs, N_user_sharing_BSS, the user fields of which BSS are first]).

As an example (e.g., of techniques applicable to DL OFDMA transmissions), the 8 values may be:
[2, 1, sharing BSS first] to indicate total 2 user fields including 1 user field for the sharing BSS followed by 1 user field for the shared BSS,
[3, 1, sharing BSS first] to indicate total 3 user fields including 1 user field for the sharing BSS followed by 2 user fields for the shared BSS,
[3, 2, sharing BSS first] to indicate total 3 user fields including 2 user fields for the sharing BSS followed by 1 user field for the shared BSS,
[4, 2, sharing BSS first] to indicate total 4 user fields including 2 user fields for the sharing BSS followed by 2 user fields for the shared BSS,
[2, 1, shared BSS first] to indicate total 2 user fields including 1 user field for the shared BSS followed by 1 user field for the sharing BSS,
[3, 1, shared BSS first] to indicate total 3 user fields including 2 user fields for the shared BSS followed by 1 user field for the sharing BSS,
[3, 2, shared BSS first] to indicate total 3 user fields including 1 user field for the shared BSS followed by 2 user fields for the sharing BSS, and
[4, 2, shared BSS first] to indicate total 4 user fields including 2 user fields for the shared BSS followed by 2 user fields for the sharing BSS.

There are various options for how to interpret a user field format for CoBF users. According to a first option, the MU-MIMO user field format may always be used. In such cases, all CoBF users across the two BSSs may be treated as MU-MIMIO users. The total number of users and spatial configuration subfield may be interpreted based on the total number of CoBF users across two BSSs.

According to a second option, the user field format may depend on the number of CoBF users in each BSS. For example, in each (M) RU that is in CoBF mode, if there is only one user served by one AP, the user field may use the non-MU-MIMO user field format. In this case, the start stream index for the user may depend on the order of user fields of the CoBF users across two BSSs and the total number of spatial streams of the CoBF users whose user fields are prior to this user's user field. On the other hand, if there are more than one users served by one AP, the user fields may use the MU-MIMO user field format. In this case, the total number of users and spatial configuration subfields may be interpreted based on the number of CoBF users across two BSSs and the total number of spatial streams among all CoBF users.

Aspects of the present disclosure may also help mitigate the impact of carrier frequency offset (CFO) on full-nulling case with joint NDP. Without correction to reduce or eliminate a CFO (e.g., phase tracking during LTF or data stages), the error vector magnitude observed at a receiver (Rx EVM) may increase significantly (e.g., during joint NDP and data transmission). Aspects of the present disclosure, however, may help by providing for pre-processing (e.g., phase tracking or data LTF stage phase correction) which may help reduce EVM. The mechanisms proposed herein may be used for full nulling or partial nulling cases.

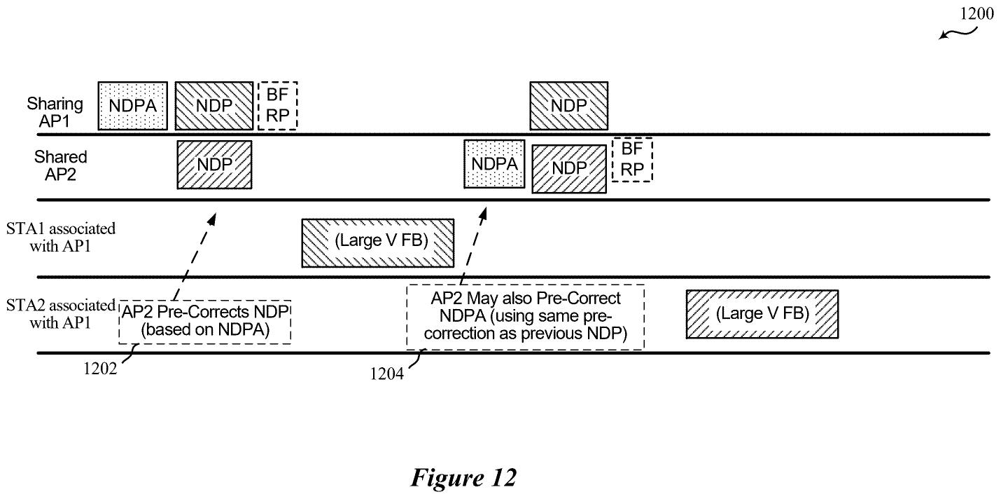

Diagram 1200 of FIG. 12 illustrates how NDP frames may be pre-corrected during a joint sounding protocol. As illustrated, sounding typically happens one BSS at a time (e.g., to collect feedback from the STAs in a given BSS). The example in FIG. 12 shows a relative simple scenario of 2 APs (AP1 and AP2) and 1 (non-AP) STA per AP (with STA1 associated with AP1 and STA 2 association with AP2).

As illustrated, an NDPA is sent from only one AP (which may be referred to as a “sounding AP”). As described above, the joint NDP, even though sent from both APs, pretends to be an NDP sent from a single “sounding AP”. As a result, only STAs associated with the sounding AP will respond with CSI feedback.

As illustrated at 1202 in FIG. 12, AP2 may perform pre-correction based on the NDPA sent from AP1. The pre-correction (e.g., phase correction) may be designed, for example, to bring the NDP from AP2 to within few hundred Hz of the NDP from AP1 to enhance joint sounding. As illustrated at 1204, in some cases, AP2 may also pre-correct its NDPA (e.g., using the same pre-correction as the previous NDP). In some cases, one AP may be assigned a role as a sync-reference AP and the other AP may be assigned a role as a sync-follower AP. In such cases, the sync-reference AP may be considered the anchor/reference and does not do pre-correction, while the sync-follower AP corrects its NDP according to the NDPA sent from the sync-reference AP. In some cases, which AP is assigned the role of sync-reference and which is assigned the role of sync-follower may be independent of which AP is a TXOP holder(s). This may make practical sense, because the CoBF (including sounding and transmission) may span multiple TXOPs and the role of TXOP holder may change.

Sequential sounding may also suffer similar impact to CFO issues. Without correction, if the two APs transmit NDPs at their frequency, the feedback tones at the two APs may differ significantly (e.g., by up-to 40 ppm). The impact may be due to one AP's precoding happening on tones which are certain number of tones (e.g., up to a few hundred kHz) apart from the transmission tones and may result in a significant loss in throughput. Thus, it may be beneficial to perform some type of pre-correction during sequential sounding.

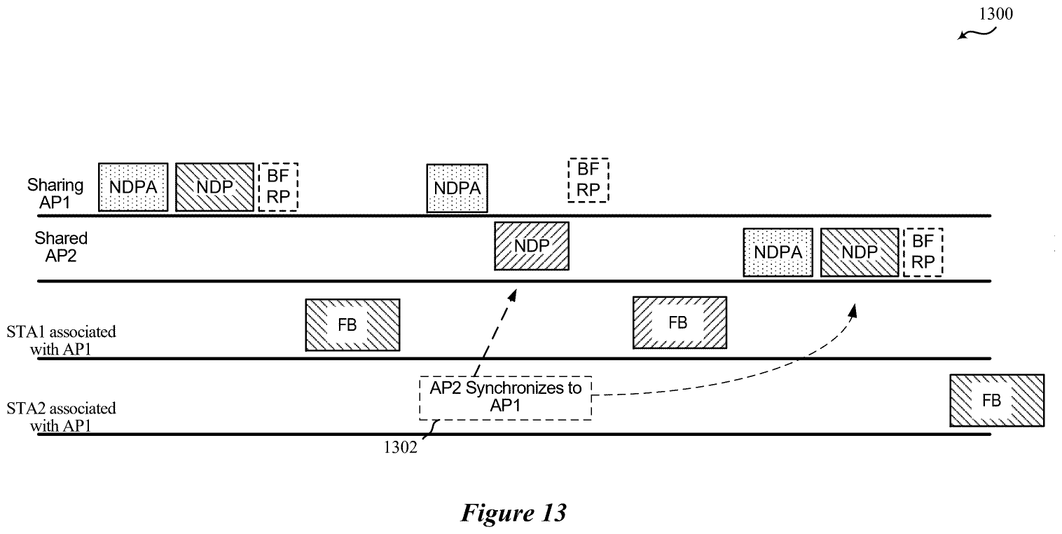

The example timeline 1300 in FIG. 13 shows an example of a sequential sounding protocol. The example again assumes 2 APs (AP1 and AP2) and 1 (non-AP) STA per AP (with STA1 associated with AP1 and STA 2 associated with AP2).

As illustrated in FIG. 13, in this case, the NDPA may be sent from only one AP (“sounding AP”), AP1 in this example. Optionally, beamforming response poll (BF RPs) may be used as triggering frames.

As illustrated at 1302, however, during actual transmission stage, the shared AP may synchronize to the sharing AP. In some cases, all NDP frames may be synchronized to a sharing AP (e.g., the transmitter of the first NDPA). For example, the first NDP sent from AP2 may be pre-corrected based on (e.g., synchronized to) the previous NDPA sent from AP1. This may be considered carrier frequency pre-correction of cross-BSS sounding in a sequential sounding procedure.

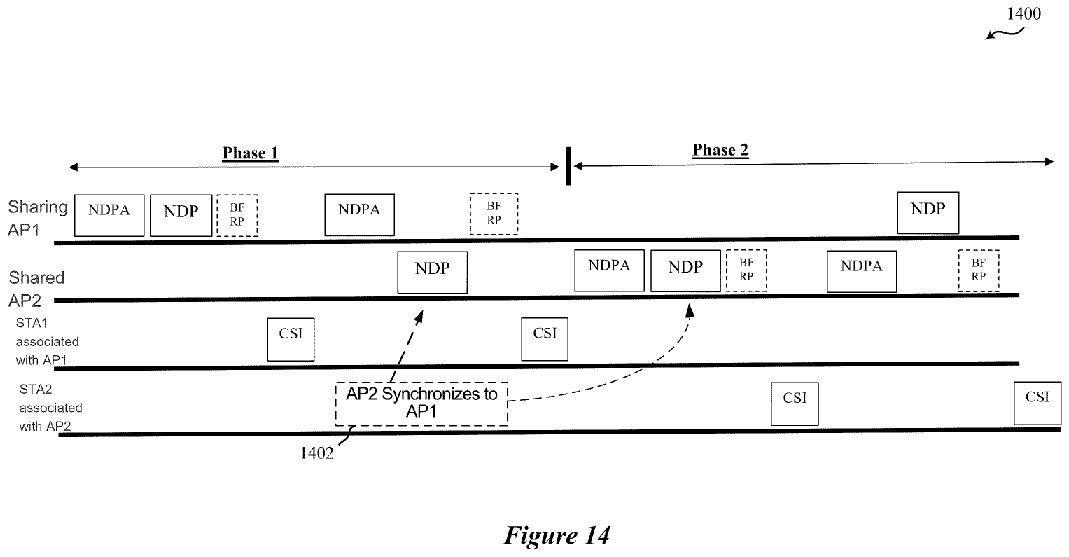

As illustrated in diagram 1400 of FIG. 14, in some cases, sounding may be performed in multiple phases (Phase 1 and Phase 2). In such cases, there are various options for how AP2 may perform pre-correction. For example, according to a first option as indicated at 1402, the shared AP (AP2) may be configured to remember the (pre) correction applied from the first phase and use that same pre-correction during the second phase when it is the transmitter of the NDP.

According to another option, the sharing AP (AP1) may transmit a synchronization frame, for example, at the beginning of second phase. AP2 may then perform pre-correction to synchronize a subsequent NDP to that synchronization frame.

In some cases, CoBF may be restricted to a full BW of a PPDU. In other cases, CoBF may be allowed on a partial BW. In some cases, if CoBF is allowed on a partial BW, different STAs may be scheduled in remaining portions of a PPDU BW by both or by one of the APs. In some cases, only one resource unit (RU) may be allowed to perform CoBF in the partial BW case. There are various options (e.g., configurations) that may allow CoBF on a portion of PPDU bandwidth. According to a first option, half of the PPDU BW may be allowed, for example, with configurations such as:
40 MHz CoBF in 80 MHz PPDU;
80 MHz CoBF in 160 MHz PPDU; or
160 MHz CoBF in 320 MHz PPDU.
   According to a second option (e.g., if latency sensitive traffic is considered), more combinations may be allowed, such as:
20/40 MHz CoBF in 80 MHz PPDU;
40/80 MHz CoBF in 160 MHz PPDU; or
80/160 MHz CoBF in 320 MHz PPDU.

In some cases, providing information regarding bandwidth utilization of an AP may be beneficial and lead to improved resource utilization. For example, it may be beneficial to have multiple bandwidth fields to be present in the SIG fields, with each one corresponding to a PPDU BW of a different participating AP in the CoBF transmission.

The benefit of such information may be understood by considering a case where one of the APs (AP2) may be transmitting 80 MHz CoBF, but participating in other activity in a secondary 80 MHz. AP2 may be doing CoBF only in the primary 80 MHz, but not transmitting in the secondary 80 MHz. In this case, it may be beneficial to include bandwidth fields of the PPDUs being transmitted by the two APs separately, for example, in a SIG field (e.g., either U-SIG or UHR-SIG common). For example, a BSS which is only close to AP2 may benefit in increased reuse opportunities or doing non-primary channel access if it knows that the ongoing transmission is only 80 MHz and not 160 MHz. Of course, the scenario involving 80/160 MHz is just one example, and similar situations may arise with different BW configurations, such as 160/320 MHz.

In some cases, it may be beneficial to provide signaling regarding a number of receive antennas (Nrx) at a STA. For example, there are certain occasions when a STA might benefit from reducing the number of receive antennas (Nrx). Such occasions may include, for example, a partial nulling case with sequential sounding or a partial nulling case with joint sounding when a STA does not implement special spatial processing on the pilots.

Aspects of the present disclosure provide a signaling mechanism that allows an AP to effectively suggest whether or not a STA is to devolve to full-rank operation. For example, an AP may send an NDPA that includes a “full-rank CoBF operation recommendation ON” field. In some cases, there may be a joint sounding indication in the NDPA as well (e.g., for a special STA info field targeted to the AP to be ignored by the STAs). In some cases, an NDP following such an indication (and/or another CoBF transmission) may be processed with Nc antennas, where Nc is the number of streams (e.g., columns of V) of compressed feedback requested via the NDPA. This could apply to sequential sounding or joint sounding (e.g., when a STA does not wish to implement special phase tracking).

According to certain aspects, an AP may include some indication in the NDPA to signal that this is part of a CoBF sounding, which may have implications on the number of antennas the STA uses to calculate sounding feedback and to receive the subsequent CoBF transmission. As noted above, the NDPA may also include a joint/sequential sounding indication. The CoBF sounding indication may effectively serve as a recommendation for a STA to perform full-rank operation. In some cases, a STA may only reduce a number of antennas for sequential sounding cases.

In some cases, a CoBF transmission phase may also include an indication to tell the STA that it may reduce the number of antennas to the Nc of the most recent sounding NDPA. In some cases, a STA may perform antenna reduction only for the most recent NDPA with CoBF indication turned on. In some cases, a STA may perform antenna reduction selectively (e.g., if the most recent NDPA signaled sequential sounding and/or if the STA does not implement phase tracking).

Additionally, it may be advantageous for the AP to know the number of Rx antennas at the client STA. Therefore, in some cases, the STA and AP may participate in a capability exchange, where the STA signals the number of Rx antennas.

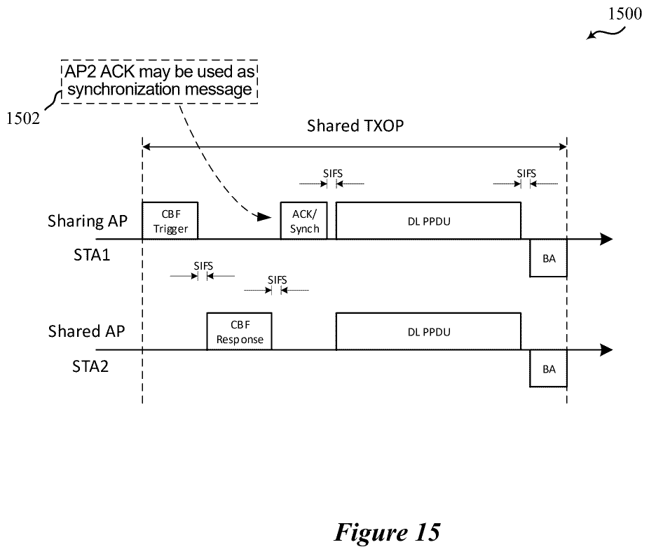

FIG. 15 shows a timing diagram 1500 for an example sequence for a CoBF transmission phase. As illustrated, via a CoBF Trigger, a sharing AP may share various common preamble information, in addition to information indicating which clients it will serve. Via a CoBF Response, a shared AP may acknowledge that it is capable of nulling its signal at sharing AP's client and declares which clients it will serve.

Via an acknowledgment (ACK), the sharing AP may also acknowledge that it can null its signal at shared AP's client. As indicate at 1502, the ACK may be used as a synchronization message. For example, the shared AP may pre-correct a subsequent CoBF transmission (e.g., a CoBF DL PPDU).

CoBF may create certain challenges regarding certain performance metrics, such as Tx EVM, for joint NDP and CoBF transmissions. Typically, in single AP MU-MIMO, an NDP is transmitted at a power level associated with a maximum MCS among the recipient users. This approach may allow channel estimation EVM for CSI feedback to keep up with a data demodulation EVM target.

For CoBF (including joint NDP), there are two APs transmitting together. As a result, there may be data demodulation EVM targets to be met in two BSSs. Aspects of the present disclosure provide various options for how to set power levels to account for EVM targets in two BSSs.

According to a first option, fixed power levels may be used in NDP and CoBF data transmissions. For example, the power levels may be fixed (e.g., through an EVM/MCS requirement specified in a standard) or via an exchange of Tx EVM level information (e.g., through negotiation before joint NDP sounding stage).

According to a second option, the power level of the NDP may be decided just before the joint sounding NDP stage. In this case, the NDPA may carry information from the sharing AP to shared AP. For example, the NDPA may carry some information about the EVM of its recipient STAs (in the sharing AP's BSS). Additionally, a frame may be sent back from the shared AP to convey its information as well.

In some cases, the decision may be to use the same power level at NDP stage as used for a subsequent CoBF data stage. In other cases, power levels at the CoBF transmission stage may be re-adjusted. For example, the power levels may be re-adjusted according to a maximum MCS across both BSSs with the benefit of fresh knowledge of channels (e.g., reflecting impact of isolation).

In some cases, APs may exchange information during the frame exchange that happens immediately before CoBF PPDU. In some cases, once a shared AP receives the NDPA, the shared AP may take the maximum MCS (or EVM) of the sharing AP and compare it to the maximum MCS (or EVM) in the shared AP's BSS. There are two possibilities for these values. If the MCS_max of AP1 (sharing AP) is greater than (or equal to) MCS_max of AP2 (shared AP), AP2 may transmits the NDP at the EVM target associated with the MCS_max of AP1.

On the other hand, if MCS_max of AP1 (sharing AP) is less than (e.g., or equal to) MCS_max of AP2 (shared AP), AP1 may be unable to reduce its TX power as it is likely that there is no frame exchange that will convey the MCS_max of AP2 to AP1. In some cases, AP2 may send some type of (e.g., compact) frame after NDPA from AP1. AP2 may, thus, have various options. AP2 may proceed accepting the impact of potentially higher EVM from AP1 during the NDP or it may reduce its maximum MCS to AP1's maximum MCS.

In case power levels are re-adjusted at the CoBF transmission stage, there are various options. For example, one possibility is to make the Tx power adjustment such that the Tx EVM is allowed to only cause an interference at the OBSS receiver which is below a threshold. This threshold may be fixed (e.g., specified in a standard) or determined based on a more sophisticated metric that ensures a certain signal to interference ratio (SIR) at the receiver. Such a metric may be designed to take into account considerations, such as isolation between the APs.

There are various examples of possible equations to calculate the power level using a more sophisticated threshold, such as:

$$Serving signal ( in - BSS ) = ( TxPower - InBSS Pathloss ) ; or$$

$$Interference level seen at OBSS Rx = ( TxPower lowered by the TxEVM ) - ( Pathloss to OBSS STA ) .$$

Another example equation may be designed to ensure that:

$$Serving signal - Interference Level > Threshold ( function of in - BSS MCS ) ,$$

which may also mean that:

$$Tx EVM ( when written as positive number ) - Isolation > Thresholod ( function of in - BSS MCS ) .$$

As described above, Tx power of NDP may be adjusted to keep into account the Tx EVM target of an OBSS STA. Similarly, Tx Power of a CoBF transmission may be adjusted to keep into account the Tx EVM target of an OBSS STA.

As noted, various types of signaling between APs may be used to convey the Tx EVM requirements of their respective recipients. For example, the information may be conveyed in an NDPA. In some cases, the information may be sent in another type of frame before the NDP. In some cases, the information may be sent in a frame before a final CoBF transmission which carries the data packet. As noted above, the signaling may take the form of a maximum MCS among all the recipients in a BSS.

### Example Methods

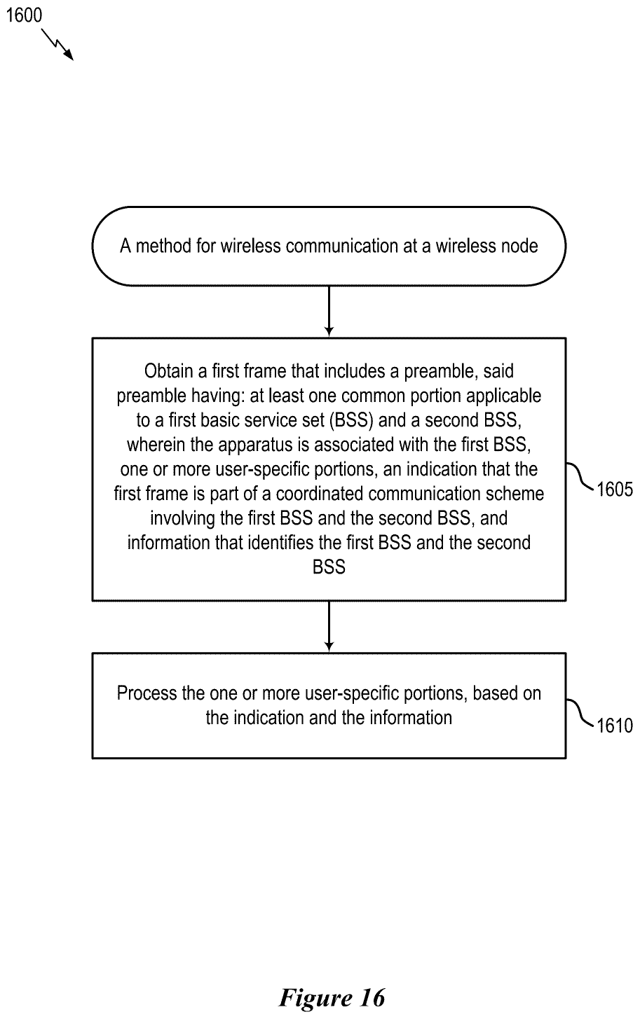

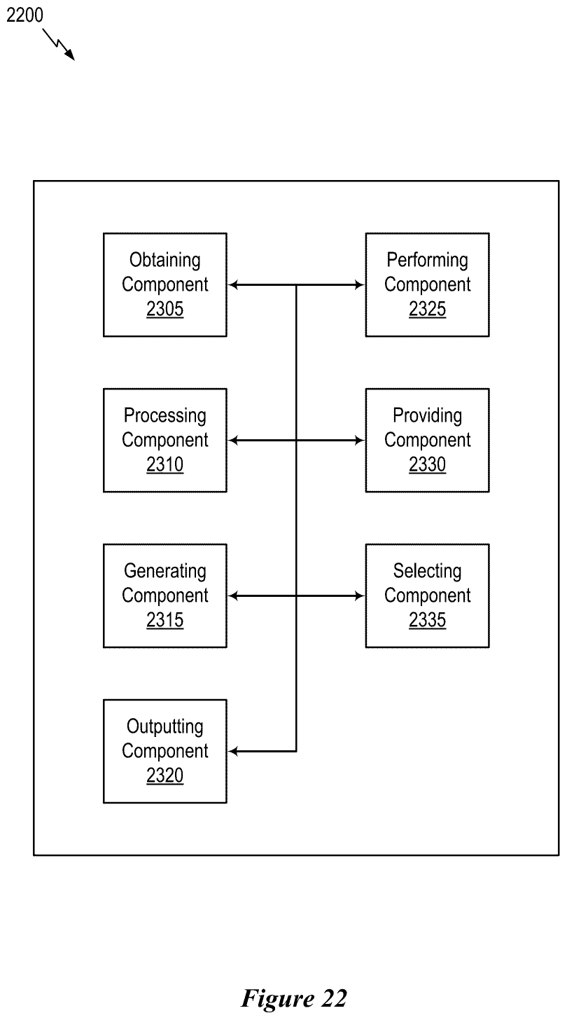

FIG. 16 shows a flowchart illustrating an example process 1600 performable by or at a wireless node. The operations of the process 1600 may be implemented by a wireless STA, or its components as described herein, and/or wireless AP, or its components as described herein. For example, the process 1600 may be performed by a wireless communication device, such as the wireless communication device 2200 described with reference to FIG. 22, operating as or within a wireless STA or operating as or within a wireless AP. In some examples, the process 1600 may be performed by a wireless STA such as one of the STAs 104 described with reference to FIG. 1. In some examples, the process 1600 may be performed by a wireless AP such as one of the APs 102 described with reference to FIG. 1.

In some examples, in block 1605, the wireless node may obtain a first frame that includes a preamble, said preamble having: at least one common portion applicable to a first basic service set (BSS) and a second BSS, wherein the apparatus is associated with the first BSS, one or more user-specific portions, an indication that the first frame is part of a coordinated communication scheme involving the first BSS and the second BSS, and information that identifies the first BSS and the second BSS. In some cases, the operations of this step refer to, or may be performed by, an obtaining component as described with reference to FIG. 22.

In some examples, in block 1610, the wireless node may process the one or more user-specific portions, based on the indication and the information. In some cases, the operations of this step refer to, or may be performed by, a processing component as described with reference to FIG. 22.

In some aspects, the first indication that the first frame is part of the coordinated communication scheme is indicative that one or more fields of the preamble includes the information that identifies the first BSS and the second BSS.

In some aspects, the one or more fields comprise at least one of: a common signal field having at least one subfield; or a MCS field or subfield of a user-specific signal field.

In some aspects, the information identifying the first BSS and the second BSS comprises at least one of a BSS ID or a BSS color.

In some aspects, the information identifying the first BSS and the second BSS comprises at least one of: first and second partial BSS IDs; or first and second BSS colors. In some aspects, the information further comprises a common BSS color.

In some aspects, processing the user-specific portions comprises: processing a first user-specific portion associated with the first BSS; and processing a second user-specific portion associated with the second BSS.

In some aspects, the first frame includes at least one bit indicating whether a corresponding user-specific portion is associated with a first wireless node that owns a TXOP in which the first frame is obtained or a second wireless node.

Note that FIG. 16 is just one example of a process, and other processes including fewer, additional, or alternative steps are possible consistent with this disclosure.

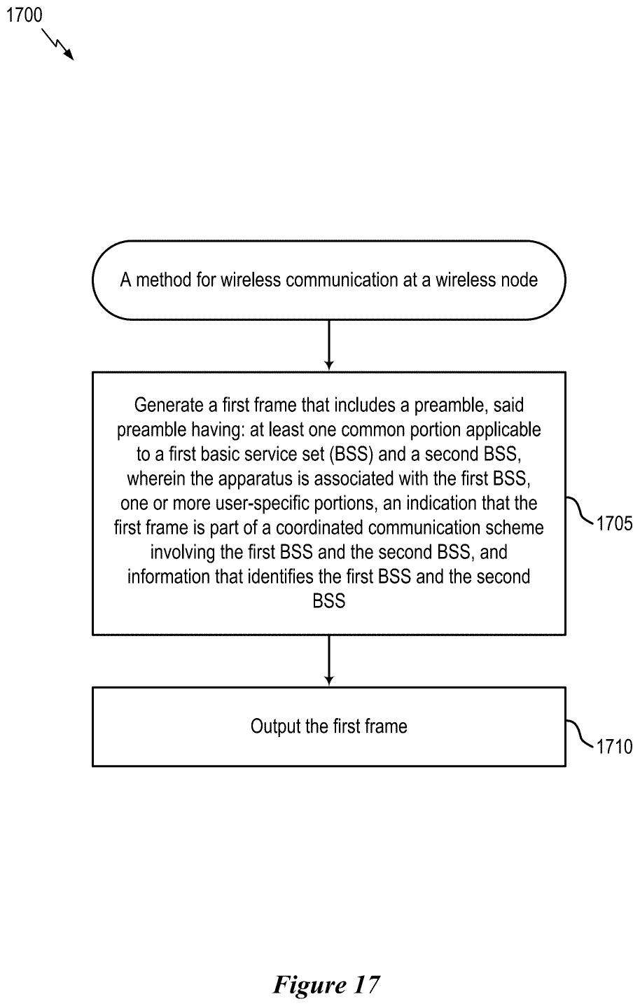

FIG. 17 shows a flowchart illustrating an example process 1700 performable by or at a wireless node. The operations of the process 1700 may be implemented by a wireless STA, or its components as described herein, and/or wireless AP, or its components as described herein. For example, the process 1700 may be performed by a wireless communication device, such as the wireless communication device 2200 described with reference to FIG. 22, operating as or within a wireless STA or operating as or within a wireless AP. In some examples, the process 1700 may be performed by a wireless STA such as one of the STAs 104 described with reference to FIG. 1. In some examples, the process 1700 may be performed by a wireless AP such as one of the APs 102 described with reference to FIG. 1.

In some examples, in block 1705, the wireless node may generate a first frame that includes a preamble, said preamble having: at least one common portion applicable to a first basic service set (BSS) and a second BSS, wherein the apparatus is associated with the first BSS, one or more user-specific portions, an indication that the first frame is part of a coordinated communication scheme involving the first BSS and the second BSS, and information that identifies the first BSS and the second BSS. In some cases, the operations of this step refer to, or may be performed by, a generating component as described with reference to FIG. 22.

In some examples, in block 1710, the wireless node may output the first frame. In some cases, the operations of this step refer to, or may be performed by, an outputting component as described with reference to FIG. 22.

In some aspects, the first indication that the first frame is part of the coordinated communication scheme is indicative that one or more fields of the preamble includes the information that identifies the first BSS and the second BSS.

In some aspects, the one or more fields comprise at least one of: a common signal field having at least one subfield; or a MCS field or subfield of a user-specific signal field.

In some aspects, the information identifying the first BSS and the second BSS comprises at least one of a BSS ID or a BSS color.

In some aspects, the information identifying the first BSS and the second BSS comprises at least one of: first and second partial BSS IDs; or first and second BSS colors.

In some aspects, the information further comprises a common BSS color.

In some aspects, the first frame includes at least one bit indicating whether a corresponding user-specific portion is associated with a first wireless node that owns a TXOP in which the first frame is obtained or a second wireless node.

Note that FIG. 17 is just one example of a process, and other processes including fewer, additional, or alternative steps are possible consistent with this disclosure.

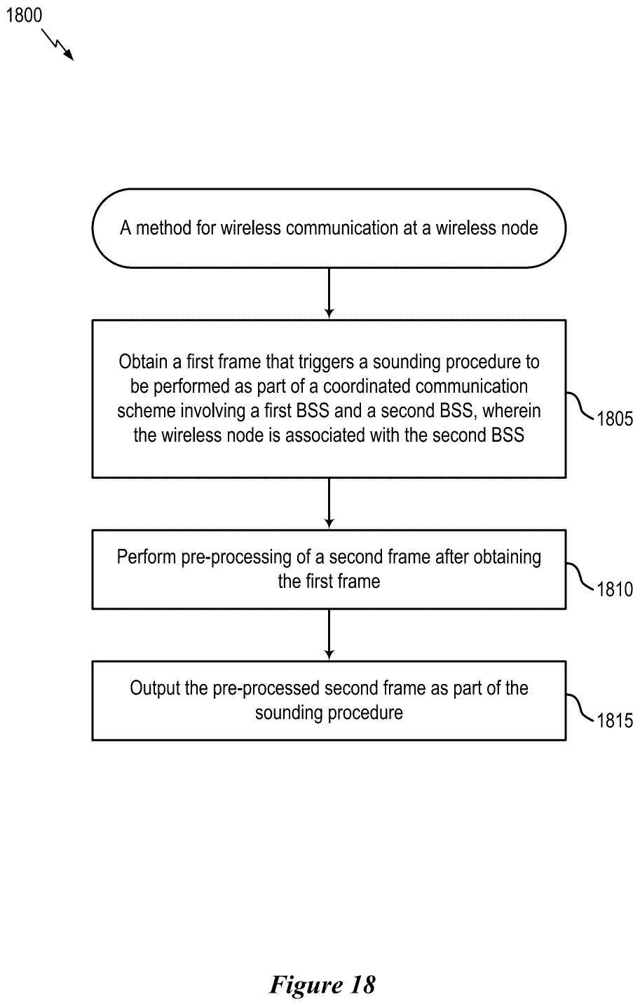

FIG. 18 shows a flowchart illustrating an example process 1800 performable by or at a wireless node. The operations of the process 1800 may be implemented by a wireless STA, or its components as described herein, and/or wireless AP, or its components as described herein. For example, the process 1800 may be performed by a wireless communication device, such as the wireless communication device 2200 described with reference to FIG. 22, operating as or within a wireless STA or operating as or within a wireless AP. In some examples, the process 1800 may be performed by a wireless STA such as one of the STAs 104 described with reference to FIG. 1. In some examples, the process 1800 may be performed by a wireless AP such as one of the APs 102 described with reference to FIG. 1.

In some examples, in block 1805, the wireless node may obtain a first frame that triggers a sounding procedure to be performed as part of a coordinated communication scheme involving a first BSS and a second BSS, wherein the wireless node is associated with the second BSS. In some cases, the operations of this step refer to, or may be performed by, an obtaining component as described with reference to FIG. 22.

In some examples, in block 1810, the wireless node may perform pre-processing of a second frame after obtaining the first frame. In some cases, the operations of this step refer to, or may be performed by, a performing component as described with reference to FIG. 22.

In some examples, in block 1815, the wireless node may output the pre-processed second frame as part of the sounding procedure. In some cases, the operations of this step refer to, or may be performed by, an outputting component as described with reference to FIG. 22.

In some aspects, the first frame comprise a NDPA; and the second frame comprises an NDP.

In some aspects, the pre-processing comprises pre-correction of the second frame to achieve a frequency target relative to the first frame.

In some aspects, the frequency target triggers the second frame to be output for transmission at a frequency that is within a range from a frequency at which the first frame was obtained.

In some aspects, the process 1800 further includes performing pre-processing of at least a third frame after obtaining the first frame. In some cases, the operations of this step refer to, or may be performed by, a performing component as described with reference to FIG. 22.

In some aspects, the process 1800 further includes outputting the pre-processed third frame as part of the sounding procedure. In some cases, the operations of this step refer to, or may be performed by, an outputting component as described with reference to FIG. 22.

In some aspects, the third frame comprise at least one of a NDPA or an NDP.

In some aspects, the pre-processing comprises synchronizing the second frame to the first frame.

In some aspects, the process 1800 further includes performing pre-processing of at least a third frame the first frame. In some cases, the operations of this step refer to, or may be performed by, a performing component as described with reference to FIG. 22.

In some aspects, the process 1800 further includes outputting the pre-processed third frame as part of the sounding procedure. In some cases, the operations of this step refer to, or may be performed by, an outputting component as described with reference to FIG. 22.

In some aspects, the third frame comprises at least one of a NDPA or an NDP.

In some aspects, the process 1800 further includes obtaining at least a third frame. In some cases, the operations of this step refer to, or may be performed by, an obtaining component as described with reference to FIG. 22.

In some aspects, the process 1800 further includes performing pre-processing of at least a fourth frame, based on the third frame. In some cases, the operations of this step refer to, or may be performed by, a performing component as described with reference to FIG. 22.

In some aspects, the process 1800 further includes outputting the pre-processed fourth frame as part of the sounding procedure. In some cases, the operations of this step refer to, or may be performed by, an outputting component as described with reference to FIG. 22.

Note that FIG. 18 is just one example of a process, and other processes including fewer, additional, or alternative steps are possible consistent with this disclosure.

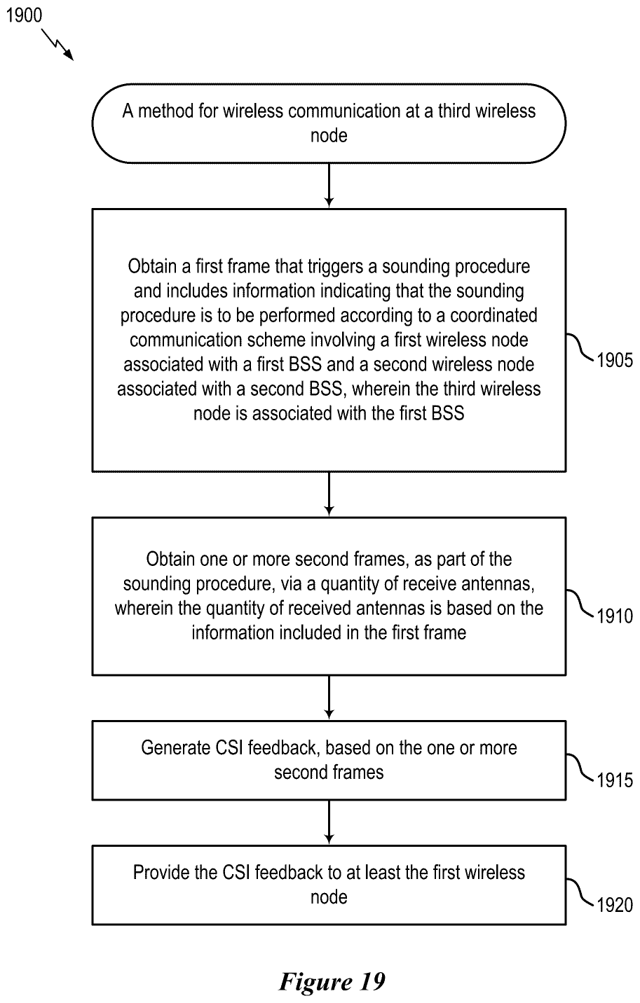

FIG. 19 shows a flowchart illustrating an example process 1900 performable by or at a third wireless node. The operations of the process 1900 may be implemented by a wireless STA, or its components as described herein, and/or wireless AP, or its components as described herein. For example, the process 1900 may be performed by a wireless communication device, such as the wireless communication device 2200 described with reference to FIG. 22, operating as or within a wireless STA or operating as or within a wireless AP. In some examples, the process 1900 may be performed by a wireless STA such as one of the STAs 104 described with reference to FIG. 1. In some examples, the process 1900 may be performed by a wireless AP such as one of the APs 102 described with reference to FIG. 1.

In some examples, in block 1905, the third wireless node may obtain a first frame that triggers a sounding procedure and includes information indicating that the sounding procedure is to be performed according to a coordinated communication scheme involving a first wireless node associated with a first BSS and a second wireless node associated with a second BSS, wherein the third wireless node is associated with the first BSS. In some cases, the operations of this step refer to, or may be performed by, an obtaining component as described with reference to FIG. 22.

In some examples, in block 1910, the third wireless node may obtain one or more second frames, as part of the sounding procedure, via a quantity of receive antennas, wherein the quantity of received antennas is based on the information included in the first frame. In some cases, the operations of this step refer to, or may be performed by, an obtaining component as described with reference to FIG. 22.

In some examples, in block 1915, the third wireless node may generate CSI feedback, based on the one or more second frames. In some cases, the operations of this step refer to, or may be performed by, a generating component as described with reference to FIG. 22.

In some examples, in block 1920, the third wireless node may provide the CSI feedback to at least the first wireless node. In some cases, the operations of this step refer to, or may be performed by, a providing component as described with reference to FIG. 22.

In some aspects, the process 1900 further includes selecting a quantity of receive antennas associated with a full-rank operation, the selection being based on the information included in the first frame (e.g., wherein the information in the first frame is obtained via a bit in the first frame, such as a “full-rank operation indication” bit). In some cases, the operations of this step refer to, or may be performed by, a selecting component as described with reference to FIG. 22.

In some aspects, the first frame comprises a NDPA frame; and the one or more second frames comprise one or more NDPs.

In some aspects, the information indicates whether the sounding procedure involves: a joint NDP to be obtained by the third wireless node simultaneously from the first wireless node and the second wireless node; or a sequence of NDPs obtained sequentially from the first wireless node and the second wireless node.

In some aspects, the process 1900 further includes obtaining the one or more second frames via a first quantity of receive antennas if the information indicates the sounding procedure involves a joint NDP; or. In some cases, the operations of this step refer to, or may be performed by, an obtaining component as described with reference to FIG. 22.

In some aspects, the process 1900 further includes obtaining the one or more second frames via a second quantity of receive antennas if the information indicates the sounding procedure involves a sequence of NDPs, wherein the second quantity is less than the first quantity. In some cases, the operations of this step refer to, or may be performed by, an obtaining component as described with reference to FIG. 22.

In some aspects, if at least one condition is met: the information indicates the third wireless node is allowed to select the quantity of receive antennas based on a parameter indicative of a quantity of spatial streams; and the quantity of spatial streams is indicated in an NDPA frame triggering a previous sounding procedure.

In some aspects, the at least one condition is considered met if the NDPA frame triggering the previous sounding procedure indicates the previous sounding procedure is performed according to the coordinated communication scheme.

In some aspects, the at least one condition is considered met if the NDPA frame triggering the previous sounding procedure indicates the previous sounding procedure involved a sequence of NDPs obtained sequentially by the third wireless node from the first wireless node and the second wireless node.

In some aspects, the at least one condition is considered met if the third wireless node participates in the sounding procedure independent of an ability of the third wireless node to perform multi-node phase tracking during a sounding procedure associated with the coordinated communication scheme.

In some aspects, the process 1900 further includes providing an indication of the quantity of receive antennas. In some cases, the operations of this step refer to, or may be performed by, a providing component as described with reference to FIG. 22.

Note that FIG. 19 is just one example of a process, and other processes including fewer, additional, or alternative steps are possible consistent with this disclosure.

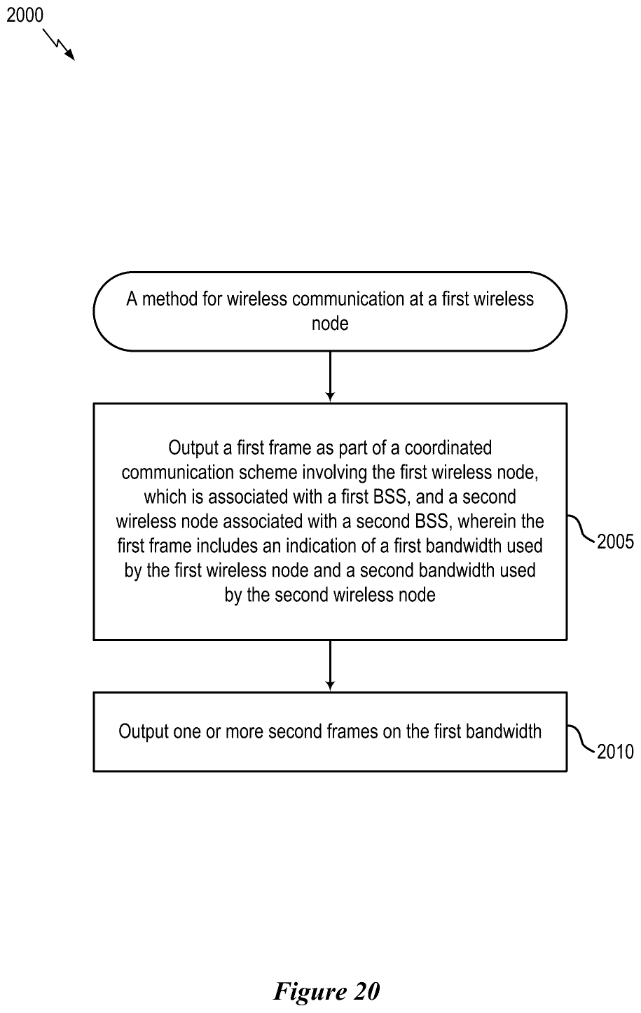

FIG. 20 shows a flowchart illustrating an example process 2000 performable by or at a first wireless node. The operations of the process 2000 may be implemented by a wireless STA, or its components as described herein, and/or wireless AP, or its components as described herein. For example, the process 2000 may be performed by a wireless communication device, such as the wireless communication device 2200 described with reference to FIG. 22, operating as or within a wireless STA or operating as or within a wireless AP. In some examples, the process 2000 may be performed by a wireless STA such as one of the STAs 104 described with reference to FIG. 1. In some examples, the process 2000 may be performed by a wireless AP such as one of the APs 102 described with reference to FIG. 1.

In some examples, in block 2005, the first wireless node may output a first frame as part of a coordinated communication scheme involving the first wireless node, which is associated with a first BSS, and a second wireless node associated with a second BSS, wherein the first frame includes an indication of a first bandwidth used by the first wireless node and a second bandwidth used by the second wireless node. In some cases, the operations of this step refer to, or may be performed by, an outputting component as described with reference to FIG. 22.

In some examples, in block 2010, the first wireless node may output one or more second frames on the first bandwidth. In some cases, the operations of this step refer to, or may be performed by, an outputting component as described with reference to FIG. 22.

In some aspects, the indication is conveyed via one or more fields in the first frame.

In some aspects, the first frame includes at least one common portion; and the one or more fields are located in the at least one common portion.

In some aspects, the one or more fields comprise one or more signal fields.

In some aspects, the first frame also includes an indication that the first frame is part of the coordinated communication scheme.

Note that FIG. 20 is just one example of a process, and other processes including fewer, additional, or alternative steps are possible consistent with this disclosure.

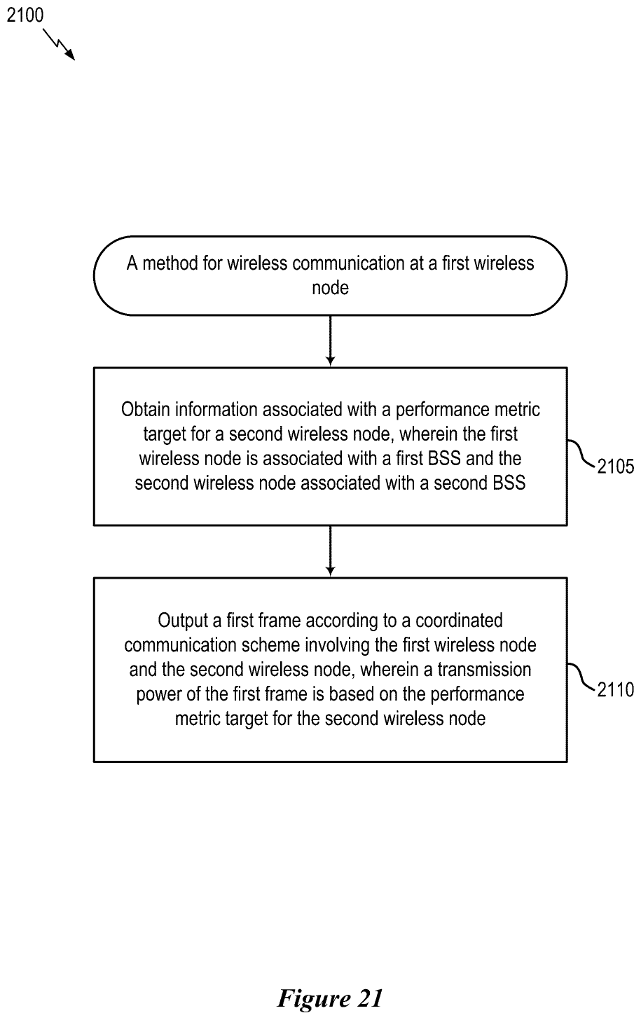

FIG. 21 shows a flowchart illustrating an example process 2100 performable by or at a first wireless node. The operations of the process 2100 may be implemented by a wireless STA, or its components as described herein, and/or wireless AP, or its components as described herein. For example, the process 2100 may be performed by a wireless communication device, such as the wireless communication device 2200 described with reference to FIG. 22, operating as or within a wireless STA or operating as or within a wireless AP. In some examples, the process 2100 may be performed by a wireless STA such as one of the STAs 104 described with reference to FIG. 1. In some examples, the process 2100 may be performed by a wireless AP such as one of the APs 102 described with reference to FIG. 1.

In some examples, in block 2105, the first wireless node may obtain information associated with a performance metric target for a second wireless node, wherein the first wireless node is associated with a first BSS and the second wireless node associated with a second BSS. In some cases, the operations of this step refer to, or may be performed by, an obtaining component as described with reference to FIG. 22.

In some examples, in block 2110, the first wireless node may output a first frame according to a coordinated communication scheme involving the first wireless node and the second wireless node, wherein a transmission power of the first frame is based on the performance metric target for the second wireless node. In some cases, the operations of this step refer to, or may be performed by, an outputting component as described with reference to FIG. 22.

In some aspects, the performance metric comprises an EVM metric.

In some aspects, the information is included in a second frame obtained from the wireless node before the first frame is output.

In some aspects, the information indicates a maximum MCS among members of the second BSS.

In some aspects, the information indicates at least one of: an explicit EVM target; a SIR; or information regarding isolation observed in the second BSS.

In some aspects, the first frame comprises a NDP output, after the second frame was obtained, as part of a sounding procedure.

In some aspects, the second frame comprises an NDPA frame that triggers the sounding procedure.

In some aspects, the first frame comprises a joint NDP frame output in coordination with the wireless node.

In some aspects, the first frame comprises a data packet output in coordination with the second wireless node.

In some aspects, the coordinated communication scheme involves CoBF.

Note that FIG. 21 is just one example of a process, and other processes including fewer, additional, or alternative steps are possible consistent with this disclosure.

### Example Device(s)

FIG. 22 shows a block diagram of an example wireless communication device 2200. In some examples, the wireless communication device 2200 is configured to perform the process 1600 described with reference to FIG. 16. In some examples, the wireless communication device 2200 is configured to perform the process 1700 described with reference to FIG. 17. In some examples, the wireless communication device 2200 is configured to perform the process 1800 described with reference to FIG. 18. In some examples, the wireless communication device 2200 is configured to perform the process 1900 described with reference to FIG. 19. In some examples, the wireless communication device 2200 is configured to perform the process 2000 described with reference to FIG. 20. In some examples, the wireless communication device 2200 is configured to perform the process 2100 described with reference to FIG. 21.

The wireless communication device 2200 may include one or more chips, SoCs, chipsets, packages, components or devices that individually or collectively constitute or include a processing system. The processing system may interface with other components of the wireless communication device 2200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 2200 may transmit the information output from the chip. In such an example, the second interface may refer to an interface between the processing system of the chip and a reception component, such that the device 2200 may receive information that is passed to the processing system. In some such examples, the first interface also may obtain information, such as from the transmission component, and the second interface also may output information, such as to the reception component.

The processing system of the wireless communication device 2200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 2200 can be configurable or configured for use in a STA, such as the STA 104 described with reference to FIG. 1. In some other examples, the wireless communication device 2200 can be a STA that includes such a processing system and other components including multiple antennas. In some examples, the wireless communication device 2200 can be configurable or configured for use in an AP, such as the AP 102 described with reference to FIG. 1. In some other examples, the wireless communication device 2200 can be an AP that includes such a processing system and other components including multiple antennas. The wireless communication device 2200 is capable of transmitting and receiving wireless communications in the form of, for example, wireless packets. For example, the wireless communication device 2200 can be configurable or configured to transmit and receive packets in the form of physical layer PPDUs and MPDUs conforming to one or more of the IEEE 802.11 family of wireless communication protocol standards. In some other examples, the wireless communication device 2200 can be configurable or configured to transmit and receive signals and communications conforming to one or more 3GPP specifications including those for 5G NR or 6G. In some examples, the wireless communication device 2200 also includes or can be coupled with one or more application processors which may be further coupled with one or more other memories. In some examples, the wireless communication device 2200 further includes a user interface (UI) (such as a touchscreen or keypad) and a display, which may be integrated with the UI to form a touchscreen display that is coupled with the processing system. In some examples, the wireless communication device 2200 may further include one or more sensors such as, for example, one or more inertial sensors, accelerometers, temperature sensors, pressure sensors, or altitude sensors, that are coupled with the processing system. In some examples, the wireless communication device 2200 further includes at least one external network interface coupled with the processing system that enables communication with a core network or backhaul network that enables the wireless communication device 2200 to gain access to external networks including the Internet.

The wireless communication device 2200 includes obtaining component 2205, processing component 2210, generating component 2215, outputting component 2220, performing component 2225, providing component 2230, and selecting component 2235. Portions of one or more of the components 2205, 2210, 2215, 2220, 2225, 2230, and 2235 may be implemented at least in part in hardware or firmware. For example one or more of the components 2205, 2210, 2215, 2220, 2225, 2230, and 2235 may be implemented at least in part by a processor or a modem. In some examples, portions of one or more of the components 2205, 2210, 2215, 2220, 2225, 2230, and 2235 may be implemented at least in part by a processor and software in the form of processor-executable code stored in a memory.

### Example Clauses

Implementation examples are described in the following numbered clauses.

Clause 1: A method for wireless communications at a first wireless node, comprising: obtaining a first frame that includes a preamble, said preamble having: at least one common portion applicable to a first basic service set (BSS) and a second BSS, wherein the first wireless node is associated with the first BSS, one or more user-specific portions, an indication that the first frame is part of a coordinated communication scheme involving the first BSS and the second BSS, and information that identifies the first BSS and the second BSS; and processing the one or more user-specific portions, based on the indication and the information.

Clause 2: The method of Clause 1, wherein the first frame is obtained in conjunction with another first frame that: is associated with a second wireless node and also associated with the second BSS, and also includes the same at least one common portion of the preamble.

Clause 3: The method of Clause 2, wherein the at least one common portion comprises: a first portion included in a signal field of a first type; and a second portion included in a signal field of a second type.

Clause 4: The method of any one of Clauses 1-3, wherein: the one or more user-specific portions comprise one or more user-specific portions intended for one or more first wireless nodes served by the first wireless node; and the first frame is obtained in conjunction with another first frame that: is associated with a second wireless node and also associated with the second BSS, includes the at least one common portion of the preamble, and also includes one or more user-specific portions intended for third wireless nodes served by the second wireless node.

Clause 5: The method of any one of Clauses 1-4, wherein: the at least one common portion and the one or more user-specific portions are obtained in a non-beamformed portion of the first frame; and the first frame also includes a beamformed portion after the non-beamformed portion.

Clause 6: The method of any one of Clauses 1-5, wherein the indication that the first frame is part of the coordinated communication scheme also indicates that one or more fields of the preamble include the information that identifies the first BSS and the second BSS.

Clause 7: The method of Clause 6, wherein the one or more fields comprise at least one of: a common signal field; a modulation and coding scheme (MCS) field; an MCS subfield of a user-specific signal field; or the user-specific signal field.

Clause 8: The method of any one of Clauses 1-7, wherein the information identifying the first BSS and the second BSS comprises at least one of a BSS identifier (BSS ID) or a BSS color.

Clause 9: The method of any one of Clauses 1-8, wherein the information identifying the first BSS and the second BSS comprises at least one of: first and second partial BSS identifiers (BSS IDs); or first and second BSS colors.

Clause 10: The method of Clause 9, wherein the first BSS color indicates a BSS associated with a first wireless node that owns a transmit opportunity (TXOP) and the second BSS color indicates a BSS associated a second wireless node that shares the TXOP with the first wireless node.

Clause 11: The method of any one of Clauses 1-10, wherein: the information identifying the first BSS comprises a first set of bits of a universal signal (U-SIG) field; and the information identifying the second BSS comprises a second set of bits of a universal signal (U-SIG) field.

Clause 12: The method of any one of Clauses 1-11, wherein the first frame includes at least one bit indicating whether a corresponding user-specific portion is associated with the first BSS or the second BSS.

Clause 13: The method of any one of Clauses 1-12, wherein the information that identifies the first BSS and the second BSS is conveyed via a user field having a coding bit associated with non COBF transmissions.

Clause 14: A method for wireless communication at a second wireless node, comprising: generating a first frame that includes a preamble, said preamble having: at least one common portion applicable to a first basic service set (BSS) and a second BSS, wherein the second wireless node is associated with the first BSS, one or more user-specific portions, an indication that the first frame is part of a coordinated communication scheme involving the first BSS and the second BSS, and information that identifies the first BSS and the second BSS; and outputting the first frame.

Clause 15: The method of Clause 14, wherein the first frame is output in conjunction with another first frame that: is associated with a second wireless node and also associated with the second BSS, and also includes the same at least one common portion of the preamble.

Clause 16: The method of Clause 15, wherein the at least one common portion comprises: a first portion included in a signal field of a first type; and a second portion included in a signal field of a second type.

Clause 17: The method of any one of Clauses 14-16, wherein: the one or more user-specific portions comprise one or more user-specific portions intended for one or more first wireless nodes served by the second wireless node; and the first frame is output in conjunction with another first frame that: is associated with a second wireless node and also associated with the second BSS, includes the at least one common portion of the preamble, and also includes one or more user-specific portions intended for third wireless nodes.

Clause 18: The method of any one of Clauses 14-17, wherein: the at least one common portion and the one or more user-specific portions are output in a non-beamformed portion of the first frame; and the first frame also includes a beamformed portion after the non-beamformed portion.

Clause 19: The method of any one of Clauses 14-18, wherein the indication that the first frame is part of the coordinated communication scheme is indicative that one or more fields of the preamble includes the information that identifies the first BSS and the second BSS.

Clause 20: The method of Clause 19, wherein the one or more fields comprise at least one of: a common signal field; a modulation and coding scheme (MCS) field; an MCS subfield of a user-specific signal field; or the user-specific signal field.

Clause 21: The method of any one of Clauses 14-20, wherein the information identifying the first BSS and the second BSS comprises at least one of a BSS identifier (BSS ID) or a BSS color.

Clause 22: The method of any one of Clauses 14-21, wherein the information identifying the first BSS and the second BSS comprises at least one of: first and second partial BSS identifiers (BSS IDs); or first and second BSS colors.

Clause 23: The method of Clause 22, wherein the first BSS color indicates a BSS associated with a first wireless node that owns a transmit opportunity (TXOP) and the second BSS color indicates a BSS associated a second wireless node that shares the TXOP with the first wireless node.

Clause 24: The method of any one of Clauses 14-23, wherein: the information identifying the first BSS comprises a first set of bits of a universal signal (U-SIG) field; and the information identifying the second BSS comprises a second set of bits of a universal signal (U-SIG) field.

Clause 25: The method of any one of Clauses 14-24, wherein at least one of: the first frame includes at least one bit indicating whether a corresponding user-specific portion is associated with the first BSS or the second BSS; or the information that identifies the first BSS and the second BSS is conveyed via a user field having a coding bit associated with non COBF transmissions.

Clause 26: A method for wireless communication at a third wireless node, including: obtaining a first frame that triggers a sounding procedure and includes information indicating that the sounding procedure is to be performed according to a coordinated communication scheme involving a first wireless node associated with a first BSS and a second wireless node associated with a second BSS, wherein the third wireless node is associated with the first BSS; obtaining one or more second frames, as part of the sounding procedure, via a quantity of receive antennas, wherein the quantity of received antennas is based on the information included in the first frame; generating CSI feedback, based on the one or more second frames; and providing the CSI feedback to at least the first wireless node.

Clause 27: The method of Clause 26, further including: selecting a quantity of receive antennas associated with a full-rank operation, the selection being based on the information included in the first frame (e.g., wherein the information in the first frame is obtained via a bit in the first frame, such as a “full-rank operation indication” bit).

Clause 28: The method any one of Clauses 26-27, where the first frame includes a NDPA frame; and the one or more second frames include one or more NDPs.

Clause 29: The method of Clause 28, where the information indicates whether the sounding procedure involves: a joint NDP to be obtained by the third wireless node simultaneously from the first wireless node and the second wireless node; or a sequence of NDPs obtained sequentially from the first wireless node and the second wireless node.

Clause 30: The method of Clause 29, further including: obtaining the one or more second frames via a first quantity of receive antennas if the information indicates the sounding procedure involves a joint NDP; or obtaining the one or more second frames via a second quantity of receive antennas if the information indicates the sounding procedure involves a sequence of NDPs, wherein the second quantity is less than the first quantity.

Clause 31: The method of Clause 28, where if at least one condition is met: the information indicates the third wireless node is allowed to select the quantity of receive antennas based on a parameter indicative of a quantity of spatial streams; and the quantity of spatial streams is indicated in an NDPA frame triggering a previous sounding procedure.

Clause 32: The method of Clause 31, where the at least one condition is considered met if the NDPA frame triggering the previous sounding procedure indicates the previous sounding procedure is performed according to the coordinated communication scheme.

Clause 33: The method of Clause 31, where the at least one condition is considered met if the NDPA frame triggering the previous sounding procedure indicates the previous sounding procedure involved a sequence of NDPs obtained sequentially by the third wireless node from the first wireless node and the second wireless node.

Clause 34: The method of Clause 31, where the at least one condition is considered met if the third wireless node participates in the sounding procedure independent of an ability of the third wireless node to perform multi-node phase tracking during a sounding procedure associated with the coordinated communication scheme.

Clause 35: The method any one of Clauses 26-34, further including: providing an indication of the quantity of receive antennas.

Clause 36: A method for wireless communication at a first wireless node, including: outputting a first frame as part of a coordinated communication scheme involving the first wireless node, which is associated with a first BSS, and a second wireless node associated with a second BSS, wherein the first frame includes an indication of a first bandwidth used by the first wireless node and a second bandwidth used by the second wireless node; and outputting one or more second frames on the first bandwidth.

Clause 37: The method of Clause 36, where the indication is conveyed via one or more fields in the first frame.

Clause 38: The method of Clause 37, where the first frame includes at least one common portion; and the one or more fields are located in the at least one common portion.

Clause 39: The method of Clause 38, where the one or more fields include one or more signal fields.

Clause 40: The method any one of Clauses 36-39, where the first frame also includes an indication that the first frame is part of the coordinated communication scheme.

Clause 41: A method for wireless communication at a first wireless node, including: obtaining information associated with a performance metric target for a second wireless node, wherein the first wireless node is associated with a first BSS and the second wireless node associated with a second BSS; and outputting a first frame according to a coordinated communication scheme involving the first wireless node and the second wireless node, wherein a transmission power of the first frame is based on the performance metric target for the second wireless node.

Clause 42: The method of Clause 41, where the performance metric includes an EVM metric.

Clause 43: The method any one of Clauses 41-42, where the information is included in a second frame obtained from the wireless node before the first frame is output.

Clause 44: The method of Clause 43, where the information indicates a maximum MCS among members of the second BSS.

Clause 45: The method of Clause 43, where the information indicates at least one of: an explicit EVM target; a SIR; or information regarding isolation observed in the second BSS.

Clause 46: The method of Clause 43, where the first frame includes a NDP output, after the second frame was obtained, as part of a sounding procedure.

Clause 47: The method of Clause 46, where the second frame includes an NDPA frame that triggers the sounding procedure.

Clause 48: The method of Clause 47, where the first frame includes a joint NDP frame output in coordination with the wireless node.

Clause 49: The method any one of Clauses 41-48, where the first frame includes a data packet output in coordination with the second wireless node.

Clause 50: The method of Clause 49, where the coordinated communication scheme involves CoBF.

Clause 51: The method of any one of Clauses 1-8, wherein the information that identifies the first BSS and the second BSS is conveyed via a coding bit of a user field.

Clause 52: The method of any one of Clauses 1-8, wherein the information that identifies the first BSS and the second BSS is conveyed via a bit of a field that indicates a quantity of one or more spatial streams.

Clause 53: The method of Clause 52, wherein the bit comprises a most significant bit (MSB) of the field that indicates the quantity of spatial streams.

Clause 54: The method of any one of Clauses 1-8, wherein the information that identifies the first BSS and the second BSS is conveyed via a field that indicates at least two of: 1) a first quantity of one or more user fields associated with the first BSS, 2) a second quantity of one or more user fields associated with the second BSS, or 3) a third quantity being a total quantity of user fields associated with the first BSS and second BSS.

Clause 55: The method of Clause 54, wherein the field also indicates an order in which the first quantity and the second quantity occurs.

Clause 56: The method of any one of Clauses 9-15, wherein the information that identifies the first BSS and the second BSS is conveyed via a coding bit of a user field.

Clause 57: The method of any one of Clauses 9-15, wherein the information that identifies the first BSS and the second BSS is conveyed via a bit of a field that indicates a quantity of one or more spatial streams.

Clause 58: The method of Clause 57, wherein the bit comprises a most significant bit (MSB) of the field that indicates the quantity of spatial streams.

Clause 59: The method of any one of Clauses 9-15, wherein the information that identifies the first BSS and the second BSS is conveyed via a field that indicates at least two of: 1) a first quantity of one or more user fields associated with the first BSS, 2) a second quantity of one or more user fields associated with the second BSS, or 3) a third quantity being a total quantity of user fields associated with the first BSS and second BSS.

Clause 60: The method of Clause 59, wherein the field also indicates an order in which the first quantity and the second quantity occurs.

Clause 61: A method for wireless communication at a wireless node, including: obtaining a first frame that triggers a sounding procedure to be performed as part of a coordinated communication scheme involving a first BSS and a second BSS, wherein the wireless node is associated with the second BSS; performing pre-processing of a second frame after obtaining the first frame; and outputting the pre-processed second frame as part of the sounding procedure.

Clause 62: The method of Clause 61, where the first frame include a NDPA; and the second frame includes an NDP.

Clause 63: The method any one of Clauses 61-62, where the pre-processing includes pre-correction of the second frame to achieve a frequency target relative to the first frame.

Clause 64: The method of Clause 63, where the frequency target triggers the second frame to be output for transmission at a frequency that is within a range from a frequency at which the first frame was obtained.

Clause 65: The method any one of Clauses 61-64, further including:
performing pre-processing of at least a third frame after obtaining the first frame; and outputting the pre-processed third frame as part of the sounding procedure.

Clause 66: The method of Clause 65, where the third frame include at least one of a NDPA or an NDP.

Clause 67: The method any one of Clauses 61-66, where the pre-processing includes synchronizing the second frame to the first frame.

Clause 68: The method any one of Clauses 61-67, further including: performing pre-processing of at least a third frame the first frame; and outputting the pre-processed third frame as part of the sounding procedure.

Clause 69: The method of Clause 68, where the third frame includes at least one of a NDPA or an NDP.

Clause 70: The method any one of Clauses 61-69, further including: obtaining at least a third frame; performing pre-processing of at least a fourth frame, based on the third frame; and outputting the pre-processed fourth frame as part of the sounding procedure.

Clause 71: A method for wireless communication at a first wireless node, comprising: outputting a first frame that indicates common information applicable to both a first basic service set (BSS) and a second BSS and also indicates one or more second wireless nodes the first wireless node will serve, wherein the first wireless node is associated with the first BSS; obtaining a second frame from a third wireless node associated with the second BSS, the second frame indicating one or more fourth wireless nodes the third wireless node will serve; and outputting a third frame to acknowledge the second frame.

Clause 72: A method for wireless communication at a third wireless node, comprising: obtaining, from a first wireless node, a first frame which indicates common information applicable to both a first basic service set (BSS) and a second BSS and also indicates one or more second wireless nodes the first wireless node will serve, wherein the first wireless node is associated with the first BSS and the third wireless node is associated with the second BSS; outputting a second frame to the first wireless node, the second frame indicating one or more fourth wireless nodes the third wireless node will serve; and obtaining, from the first wireless node, a third frame that acknowledges the second frame.

Clause 73: An apparatus, including: at least one memory including executable instructions; and at least one processor configured to execute the executable instructions and cause the apparatus to perform a method in accordance with any combination of Clauses 1-72.

Clause 74: An apparatus, including means for performing a method in accordance with any combination of Clauses 1-72.

Clause 75: A non-transitory computer-readable medium including executable instructions that, when executed by at least one processor of an apparatus, cause the apparatus to perform a method in accordance with any combination of Clauses 1-72.

Clause 76: A computer program product embodied on a computer-readable storage medium including code for performing a method in accordance with any combination of Clauses 1-72.

Clause 77: A wireless node (e.g., an AP or wireless station), comprising: at least one transceiver; at least one memory comprising instructions; and one or more processors, individually or collectively, configured to execute the instructions and cause the wireless node to perform a method in accordance with any one of clauses 1-13 or 51-55, wherein the at least one transceiver is configured to receive the first frame.

Clause 78: A wireless node (e.g., an AP or wireless station), comprising: at least one transceiver; at least one memory comprising instructions; and one or more processors, individually or collectively, configured to execute the instructions and cause the wireless node to perform a method in accordance with any one of clauses 14-25 or 56-60, wherein the at least one transceiver is configured to transmit the first frame.

Clause 79: A wireless node (e.g., an AP or wireless station), comprising: at least one transceiver; at least one memory comprising instructions; and one or more processors, individually or collectively, configured to execute the instructions and cause the wireless node to perform a method in accordance with any one of clauses 61-70, wherein the at least one transceiver is configured to receive the first frame and transmit the pre-processed second frame.

Clause 80: A wireless node (e.g., an AP or wireless station), comprising: at least one transceiver; at least one memory comprising instructions; and one or more processors, individually or collectively, configured to execute the instructions and cause the wireless node to perform a method in accordance with any one of clauses 61-70, wherein the at least one transceiver is configured to transmit the first frame and receive the one or more second frames.

Clause 81: A wireless node (e.g., an AP or wireless station), comprising: at least one transceiver; at least one memory comprising instructions; and one or more processors, individually or collectively, configured to execute the instructions and cause the wireless node to perform a method in accordance with any one of clauses 36-40, wherein the at least one transceiver is configured to transmit the first frame and transmit the one or more second frames.

Clause 82: A wireless node (e.g., an AP or wireless station), comprising: at least one transceiver; at least one memory comprising instructions; and one or more processors, individually or collectively, configured to execute the instructions and cause the wireless node to perform a method in accordance with any one of clauses 41-50, wherein the at least one transceiver is configured to transmit the first frame.

Clause 83: A wireless node (e.g., an AP or wireless station), comprising: at least one transceiver; at least one memory comprising instructions; and one or more processors, individually or collectively, configured to execute the instructions and cause the wireless node to perform a method in accordance with clause 71, wherein the at least one transceiver is configured to transmit the first frame, receive the second frame, and transmit the third frame.

Clause 84: A wireless node (e.g., an AP or wireless station), comprising: at least one transceiver; at least one memory comprising instructions; and one or more processors, individually or collectively, configured to execute the instructions and cause the wireless node to perform a method in accordance with clause 72, wherein the at least one transceiver is configured to receive the first frame, transmit the second frame, and receive the third frame.

### ADDITIONAL CONSIDERATIONS

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

Means for obtaining, means for processing, means for performing, means for outputting, means for selecting, means for pre-processing, means for generating, and means for providing may comprise one or more processors, such as one or more of the processors described above with reference to FIG. 22.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,”’ or the equivalent in context, whatever it is that is “based on ‘a,’” or “based at least in part on ‘a,”’ may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by an AP STA may also (or instead) be performed by a non-AP STA. Similarly, operations performed by a non-AP STA may also (or instead) be performed by an AP STA.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order than described.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising computer-executable instructions; and
one or more processors configured to execute the computer-executable instructions and cause the apparatus to:
obtain a first frame that includes a preamble, said preamble having:
at least one common portion applicable to a first basic service set (BSS) and a second BSS, wherein the apparatus is associated with the first BSS,
one or more user-specific portions,
an indication that the first frame is part of a coordinated communication scheme involving the first BSS and the second BSS, and
information that identifies the first BSS and the second BSS; and
process the one or more user-specific portions, based on the indication and the information.

2. The apparatus of claim 1, wherein the first frame is obtained in conjunction with another first frame that:
is associated with a second wireless node and also associated with the second BSS, and
also includes the same at least one common portion of the preamble.

3. The apparatus of claim 2, wherein the at least one common portion comprises:
a first portion included in a signal field of a first type; and
a second portion included in a signal field of a second type.

4. The apparatus of claim 1, wherein:
the one or more user-specific portions comprise one or more user-specific portions intended for one or more first wireless nodes served by the apparatus; and
the first frame is obtained in conjunction with another first frame that:
is associated with a second wireless node and also associated with the second BSS,
includes the at least one common portion of the preamble, and
also includes one or more user-specific portions intended for third wireless nodes served by the second wireless node.

5. The apparatus of claim 1, wherein:
the at least one common portion and the one or more user-specific portions are obtained in a non-beamformed portion of the first frame; and
the first frame also includes a beamformed portion after the non-beamformed portion.

6. The apparatus of claim 1, wherein the indication that the first frame is part of the coordinated communication scheme also indicates that one or more fields of the preamble include the information that identifies the first BSS and the second BSS.

7. The apparatus of claim 1, wherein the information identifying the first BSS and the second BSS comprises at least one of a BSS identifier (BSS ID) or a BSS color.

8. The apparatus of claim 1, wherein the information identifying the first BSS and the second BSS comprises at least one of:
first and second partial BSS identifiers (BSS IDs); or
first and second BSS colors.

9. The apparatus of claim 8, wherein the first BSS color indicates a BSS associated with a first wireless node that owns a transmit opportunity (TXOP) and the second BSS color indicates a BSS associated a second wireless node that shares the TXOP with the first wireless node.

10. The apparatus of claim 1, wherein:
the information identifying the first BSS comprises a first set of bits of a universal signal (U-SIG) field; and
the information identifying the second BSS comprises a second set of bits of theU-SIG field.

11. The apparatus of claim 10, wherein:
the first set of bits comprises bits B7-B12 of the U-SIG field; and
the second set of bits comprises bits B20-B25 of the U-SIG field.

12. The apparatus of claim 1, wherein the first frame includes at least one bit indicating whether a corresponding user-specific portion is associated with the first BSS or the second BSS.

13. The apparatus of claim 1, wherein the information that identifies the first BSS and the second BSS is conveyed via at least one bit of a user field, wherein the at least one bit comprises a coding bit associated with non-coordinated communication transmissions.

14. An apparatus for wireless communication, comprising:
at least one memory comprising computer-executable instructions; and
one or more processors configured to execute the computer-executable instructions and cause the apparatus to:
generate a first frame that includes a preamble, said preamble having:
at least one common portion applicable to a first basic service set (BSS) and a second BSS, wherein the apparatus is associated with the first BSS,
one or more user-specific portions,
an indication that the first frame is part of a coordinated communication scheme involving the first BSS and the second BSS, and
information that identifies the first BSS and the second BSS; and
output the first frame.

15. The apparatus of claim 14, wherein the first frame is output in conjunction with another first frame that:
is associated with a second wireless node and also associated with the second BSS, and
also includes the same at least one common portion of the preamble.

16. The apparatus of claim 15, wherein the at least one common portion comprises:
a first portion included in a signal field of a first type; and
a second portion included in a signal field of a second type.

17. The apparatus of claim 14, wherein:
the one or more user-specific portions comprise one or more user-specific portions intended for one or more first wireless nodes served by the apparatus; and
the first frame is output in conjunction with another first frame that:
is associated with a second wireless node and also associated with the second BSS,
includes the at least one common portion of the preamble, and
also includes one or more user-specific portions intended for third wireless nodes.

18. The apparatus of claim 14, wherein:
the at least one common portion and the one or more user-specific portions are output in a non-beamformed portion of the first frame; and
the first frame also includes a beamformed portion after the non-beamformed portion.

19. The apparatus of claim 14, wherein the indication that the first frame is part of the coordinated communication scheme is indicative that one or more fields of the preamble includes the information that identifies the first BSS and the second BSS.

20. The apparatus of claim 14, wherein the information identifying the first BSS and the second BSS comprises at least one of a BSS identifier (BSS ID) or a BSS color.

21. The apparatus of claim 14, wherein the information identifying the first BSS and the second BSS comprises at least one of:
first and second partial BSS identifiers (BSS IDs); or
first and second BSS colors.

22. The apparatus of claim 21, wherein the first BSS color indicates a BSS associated with a first wireless node that owns a transmit opportunity (TXOP) and the second BSS color indicates a BSS associated a second wireless node that shares the TXOP with the first wireless node.

23. The apparatus of claim 14, wherein:
the information identifying the first BSS comprises a first set of bits of a universal signal (U-SIG) field; and
the information identifying the second BSS comprises a second set of bits of the U-SIG field.

24. The apparatus of claim 23, wherein:
the first set of bits comprises bits B7-B12 of the U-SIG field; and
the second set of bits comprises bits B20-B25 of the U-SIG field.

25. The apparatus of claim 14, wherein the first frame includes at least one bit indicating whether a corresponding user-specific portion is associated with the first BSS or the second BSS.

26. The apparatus of claim 14, wherein the information that identifies the first BSS and the second BSS is conveyed via at least one bit of a user field, wherein the at least one bit comprises a coding bit associated with non-coordinated communication transmissions.
